(19) United States
(12) Patent Application Publication
(10) Pub. No.: US 2023/0143314 A1
(43) Pub. Date: May 11, 2023

(54) INFORMATION PROCESSING DEVICE, INFORMATION PROCESSING METHOD, AND STORAGE MEDIUM

(71) Applicant: NEC Corporation, Minato-ku, Tokyo (JP)

(72) Inventor: Koui NORIMATSU, Tokyo (JP)

(73) Assignee: NEC Corporation, Minato-ku, Tokyo (JP)

(21) Appl. No.: 17/910,949

(22) PCT Filed: Mar. 30, 2020
(86) PCT No.: PCT/JP2020/014549

§ 371 Date: Sep. 12, 2022

(51) Int. Cl. G06Q 50/26; G01N 23/04; G06V 40/16

(52) U.S. Cl. CPC G06Q 50/265; G01N 23/04; G06V 40/172

(57) ABSTRACT

Provided is an information processing device including an acquisition unit that acquires article information indicating an article included in baggage of a passenger in a security inspection of a first country and a providing unit that provides the article information to a device used for a procedure for an entry into a second country of the passenger.

### TECHNICAL FIELD

The present invention relates to an information processing device, an information processing method, and a storage medium.

### BACKGROUND ART

Patent Literature 1 discloses an entry/departure management card system capable of acquiring report information about baggage from an IC card carried by a passenger and automatically executing a custom inspection procedure of the passenger.

### CITATION LIST

### Patent Literature

PTL 1: Japanese Patent Application Laid-open No. 2002-30448

### SUMMARY OF INVENTION

### Technical Problem

In the entry/departure management card system illustrated in Patent Literature 1, the information of the baggage recorded in the reporting card is limited to the information of the baggage self-reported at the time of departure from the first country. For this reason, when articles that violate the regulations of the second country are included in the baggage of the passenger and the articles are not included in the contents of the report, there is a problem that the articles are missed in various procedures about entry into the second country, or a long time is required for the procedure.

Therefore, the present invention intends to provide an information processing device, an information processing method, and a storage medium capable of improving an efficiency of a procedure for the entry of a passenger.

### Solution to Problem

According to one example aspect of the invention, provided is an information processing device including an acquisition unit that acquires article information indicating an article included in baggage of a passenger in a security inspection of a first country and a providing unit that provides the article information to a device used for a procedure for an entry into a second country of the passenger.

According to another example aspect of the invention, provided is an information processing method including acquiring article information indicating an article included in baggage of a passenger in a security inspection of a first country and providing the article information to a device used for a procedure for an entry into a second country of the passenger.

According to yet another example aspect of the invention, provided is a storage medium storing a program that causes a computer to perform acquiring article information indicating an article included in baggage of a passenger in a security inspection of a first country and providing the article information to a device used for a procedure for an entry into a second country of the passenger.

According to yet another example aspect of the invention, provided is an information processing device including a first acquisition unit that acquires, in a security inspection of a first country, article information indicating an article included in baggage of a passenger who travels to a second country, a second acquisition unit that acquires a regulation relating to carrying the article into the second country, a determination unit that performs a determination process for determining whether or not carrying the article into the second country is restricted based on the article information and the regulation and a generation unit that generates guide information for guiding a procedure imposed on carrying the article into the second country to the passenger based on a result of the determination process.

### Advantageous Effects of Invention

According to the present invention, an information processing device, an information processing method, and a storage medium which can improve an efficiency of a procedure for the entry of a passenger can be provided.

### BRIEF DESCRIPTION OF DRAWINGS

FIG. 1 is a schematic diagram illustrating an example of a general configuration of an information processing system according to a first example embodiment.

FIG. 2 is a block diagram illustrating an example of a hardware configuration of a management server according to the first example embodiment.

FIG. 3 is a functional block diagram of the management server according to the first example embodiment.

FIG. 4 is a diagram illustrating an example of information stored in a user information database (DB) according to the first example embodiment.

FIG. 5 is a diagram illustrating an example of information stored in a first baggage inspection information DB according to the first example embodiment.

FIG. 6 is a diagram illustrating an example of information stored in a second baggage inspection information DB according to the first example embodiment.

FIG. 7 is a layout diagram illustrating an example of a departure area of an airport in a first country according to the first example embodiment.

FIG. 8 is a schematic diagram illustrating an example of a security inspection site according to the first example embodiment.

FIG. 9 is a schematic diagram illustrating an example of an inspection area of a trustee baggage according to the first example embodiment.

FIG. 10 is a layout diagram illustrating an example of an entry area of an airport of a second country according to the first example embodiment.

FIG. 11 is a flowchart illustrating an example of a process of the information processing system according to the first example embodiment.

FIG. 12 is a diagram illustrating an example of a captured image according to the first example embodiment.

FIG. 13 is a flowchart illustrating an example of an inspection process for a carry-on baggage of the information processing system according to the first example embodiment.

FIG. 14 is a flowchart illustrating an example of an inspection process for the trustee baggage of the information processing system according to the first example embodiment.

FIG. 15 is a sequence chart illustrating an example of a process at the time of entry examination of the information processing system according to the first example embodiment.

FIG. 16 is a diagram illustrating an example of a screen displayed on an operation terminal according to the first example embodiment.

FIG. 17 is a sequence chart illustrating an example of a process at the time of entry examination of the information processing system according to the first example embodiment.

FIG. 18 is a diagram illustrating an example of a screen displayed on an automatic gate device according to the first example embodiment.

FIG. 19 is a sequence chart illustrating an example of a process at the time of custom inspection of the information processing system according to the first example embodiment.

FIG. 20 is a diagram illustrating an example of a screen displayed on the operation terminal according to the first example embodiment.

FIG. 21 is a sequence chart illustrating an example of a process at the time of custom inspection of the information processing system according to the first example embodiment.

FIG. 22 is a diagram illustrating an example of a screen displayed on the automatic custom gate device according to the first example embodiment.

FIG. 23 is a schematic diagram illustrating an example of a general configuration of the information processing system according to a second example embodiment.

FIG. 24 is a diagram illustrating an example of information stored in a regulation information DB according to the second example embodiment.

FIG. 25 is a functional block diagram of a management server according to the second example embodiment.

FIG. 26 is a sequence chart illustrating an example of a process at the time of departure examination of the information processing system according to the second example embodiment.

FIG. 27 is a diagram illustrating an example of a screen displayed on the operation terminal according to the second example embodiment.

FIG. 28 is a sequence chart illustrating an example of a process at the time of departure examination of the information processing system according to the second example embodiment.

FIG. 29 is a diagram illustrating an example of a screen displayed on an automatic gate device according to the second example embodiment.

FIG. 30 is a schematic diagram illustrating an example of a general configuration of an information processing system according to a third example embodiment.

FIG. 31 is a sequence chart illustrating an example of a process of the information processing system according to the third example embodiment.

FIG. 32 is a functional block diagram of an information processing device according to a fourth example embodiment.

FIG. 33 is a functional block diagram of an information processing device according to a fifth example embodiment.

FIG. 34 is a diagram illustrating an example of a screen displayed on a user terminal according to a modified example embodiment.

### DESCRIPTION OF EMBODIMENTS

Exemplary example embodiments of the present invention are described below with reference to the drawings. Throughout the drawings, the same components or corresponding components are labeled with same references, and the description thereof may be omitted or simplified.

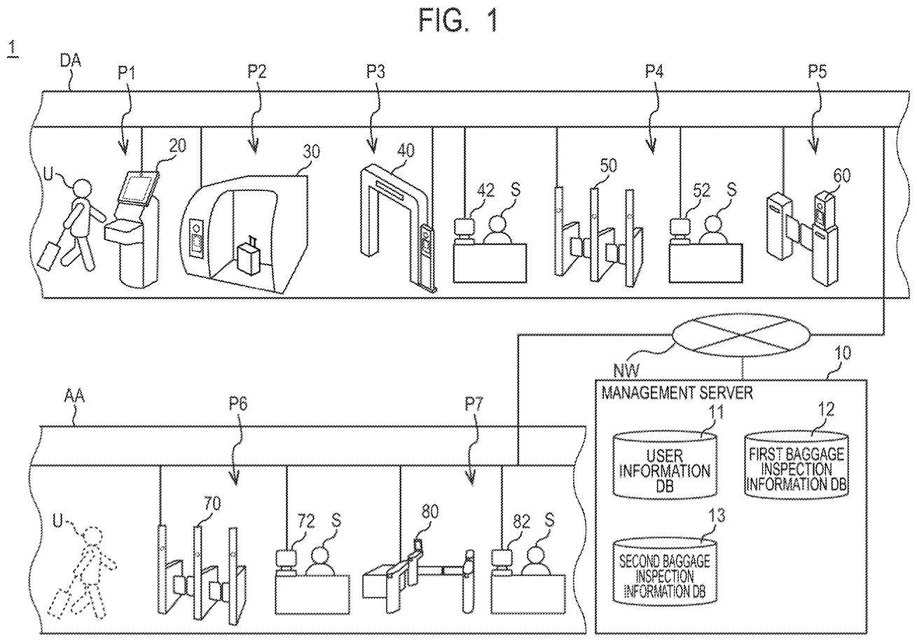

FIG. 1 is a schematic diagram illustrating an example of a general configuration of an information processing system 1 according to the present example embodiment. The information processing system 1 according to the present example embodiment is, for example, a computer system that supports a series of procedures performed in the first country and the second country with respect to a user (passenger) U who is intended to depart from the first country from an airport DA in the first country by airplane and enter the second country from an airport AA in the second country different from the first country. The information processing system 1 is operated, for example, by a public institution such as an immigration bureau or a trustee who has entrusted an operation from the institution.

As illustrated in FIG. 1, the information processing system 1 includes a management server 10, a check-in terminal 20, an automatic baggage deposition device 30, a security inspection device 40, an automatic gate device 50, a boarding gate device 60, an automatic gate device 70, an automatic custom gate device 80, and operation terminals 42, 52, 72, and 82. The management server 10 and other devices are connected to each other via a network NW. The network NW includes a local area network (LAN), a wide area network (WAN), a mobile communication network, and the like. The connection method is not limited to the wired method, and may be a wireless method.

The management server 10 is an information processing device that manages various examination procedures at the time of an enter/departure of the user U. The management server 10 is installed in a facility such as an airport DA, an airport company managing an airport AA, an airline, or the like. The management server 10 is not limited to a single server, but may be configured as a server group including a plurality of servers. For example, a server responsible for some functions of the management server 10 may be installed in the first country, and another server responsible for other functions of the management server 10 may be installed in the second country.

As illustrated in FIG. 1, the management server 10 includes a user information database (DB) 11, a first baggage inspection information DB 12, and a second baggage inspection information DB 13. However, the database of the management server 10 is not limited to these databases. The details of each database will be described later.

The check-in terminal 20 is installed in a check-in lobby (Hereinafter, it is referred to as a “touch point P1”.) in the airport DA in the first country (user departing country). The check-in terminal 20 is a self-service terminal for performing a check-in procedure (boarding procedure) by the user U operating the check-in terminal 20. When the user U completes the check-in procedure at the touch point P1, the user U moves to the deposition site of the baggage or the security inspection site.

The automatic baggage deposition device 30 is installed in an adjacent area of a baggage counter (manned counter) in the airport DA or in a vicinity area of the check-in terminal 20. Hereinafter, the procedure area in which the automatic baggage deposition device 30 is installed is referred to as a “touch point P2”. The automatic baggage deposition device 30 is a self-service terminal for performing a procedure for depositing baggage that is not carried or cannot be carried in a cabin by the user U operating the automatic baggage deposition device 30. Upon completing the baggage deposition procedure, the user U moves to the security inspection site. In the case of the user U having no baggage to be deposited, the procedure at the touch point P2 is omitted.

In the following description, the term “baggage” is used to mean both a carry-on baggage (first baggage) carried by the user U into a cabin of an airplane and a trustee baggage (second baggage) deposited by the airplane company from the user U at the touch point P2, unless otherwise specified.

The security inspection device 40 is installed in the security inspection site in the airport DA. The operation terminal 42 is installed in the manned counter of the security inspection site. The staff S uses the operation terminal 42 to perform the security inspection procedure of the user U. It is to be noted that the term “security inspection site” in the present example embodiment is used to mean not only an inspection area (Hereinafter, it is referred to as a “touch point P3”.) through which the user U passes in order to undergo a body inspection and a baggage inspection but also an inspection area on the backyard side which performs a security inspection for the deposited baggage unless otherwise specified. The term “security inspection device” is used in the meaning of including all of various devices (a passage control device 402, a baggage conveyance device 403, a camera 404, a baggage inspection device 405, a body inspection device 406, and the like, which will be described later) used for security inspection in the security inspection site.

Articles detected in the security inspection of the present example embodiment are classified into the following (A) to (D).

(A) Articles which are incapable of both carrying and depositing.

Examples of such articles include spray cans, bleaching agents, paints, fuels for lighters, articles using fire agents, and articles such as drugs.

(B) Articles which are capable of carrying (with restrictions) and incapable of depositing.

Examples of such articles include electronic cigarettes, batteries, smoking lighters, and the like.

(C) Articles which are incapable of carrying and capable of depositing.

Examples of such articles include knives, scissors, pointed articles, bats, tools, and other articles that can be weapons.

(D) Articles which may be prohibited or limited in the second country.

Examples of such articles include animals, plants, seeds of plants, foods (meat, processed meat, confectionery, etc.), gold, jewelry, watches, cigarettes, and alcoholic drinks.

Hereinafter, in the present example embodiment, for convenience of explanation, the above-described articles (A) to (D) are referred to as “prohibited articles”, “first restricted articles”, “second restricted articles” and “target articles”, respectively, and are appropriately distinguished. The above-described articles (A) to (C) are collectively referred to as “prohibited/restricted articles”. When the prohibited/restricted article is detected in the security inspection of the first country, the prohibited/restricted article is processed before the travel according to the type of the article. For example, prohibited/restricted articles are subject to changes to carry, discards, submerges, or penalty.

On the other hand, in the first country, the target article is permitted to be carried into the airplane as trustee baggage or carry-on baggage. However, the method of handling the article differs depending on the type of the article and the regulation and law in the second country. For example, when the baggage of the user U includes animals, plants, and foods, a procedure in the quarantine site may be required in the second country. In the case where a predetermined amount of money or more is contained in the baggage of the user U, a procedure in a custom inspection site may be required in the second country.

Note that in the security inspection of the first country, the articles (B) or (C) described above and carried by the airplane in an appropriate manner may also correspond to the object articles in the second country.

The automatic gate device 50 is installed in a departure examination site (Hereinafter, it is referred to as a “touch point P4”.) in the airport DA. The automatic gate device 50 is a device that automatically performs a departure examination procedure of the user U. When the departure examination procedure at the touch point P4 is completed, the user U moves to a departure area in which a tax-free shop or a boarding gate is provided. The operation terminal 52 is installed in a manned counter of a departure examination site. The staff S uses the operation terminal 42 to perform the departure examination procedure of the user U.

The boarding gate device 60 is a gate device installed for each boarding gate of the departure area (Hereinafter, it is referred to as a “touch point P5”.). The boarding gate device 60 confirms that the user U is a passenger of an airplane that can board through the boarding gate. When the user U completes the procedure at the touch point P5, the user U boards the airplane and enters the second country.

The automatic gate device 70 is installed in an entry examination site (Hereinafter, it is referred to as a “touch point P6”.) in an airport AA of the second country (user arriving country). The automatic gate device 70 is a device that automatically performs an entry examination procedure of the user U. The user U who can use the automatic gate device 70 is, for example, a person who performs preregistration regarding the use of the automatic gate device 70. The operation terminal 72 is installed in a manned counter of an entry examination site. The staff S uses the operation terminal 72 to perform the entry examination procedure of the user U.

The automatic custom gate device 80 is installed in a custom inspection site (Hereinafter, it is referred to as a “touch point P7”.) in the airport AA of the second country. The automatic custom gate device 80 is a device that automatically performs a custom inspection procedure of the user U. The user U who can use the automatic custom gate device 80 is, for example, a person who performs preregistration regarding the use of the automatic custom gate device 80. The operation terminal 82 is installed in a manned counter of the custom inspection site. The staff S uses the operation terminal 82 to perform the custom inspection procedure of the user U.

The operation terminals 42, 52, 72, and 82 are terminals used by the staff S of an airline or an airport facility for respective operations. The operation terminals 42, 52, 72, and 82 are, for example, personal computers, tablet terminals, and smartphones. In the present example embodiment, for convenience of explanation, only the operation terminals 42, 52, 72, and 82 at the touch points P3, P4, P6, and P7 are illustrated, but the operation terminals are similarly installed at other touch points.

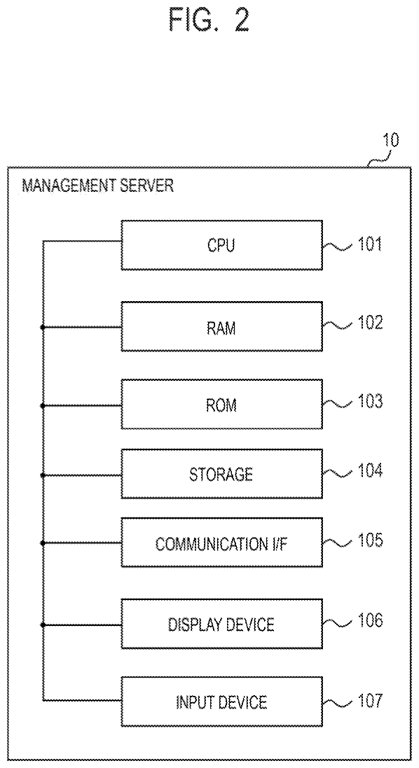

FIG. 2 is a block diagram illustrating an example of a hardware configuration of the management server 10. As illustrated in FIG. 2, the management server 10 includes, as a computer that performs calculation, control, and storage, a central processing unit (CPU) 101, a random access memory (RAM) 102, a read only memory (ROM) 103, a storage 104, a communication interface (I/F) 105, a display device 106, and an input device 107. The devices are connected to each other via a bus, a wiring, a driving device, and the like.

The CPU 101 is a processor having a function of performing a predetermined operation in accordance with a program stored in the ROM 103 or the storage 104 and controlling each unit of the management server 10. The RAM 102 is composed of a volatile storage medium and provides a temporary memory area necessary for the operation of the CPU 101.

The ROM 103 is composed of a non-volatile storage medium, and stores necessary information such as a program used for the operation of the management server 10. The storage 104 is composed of a non-volatile storage medium, and stores operation programs and data of the management server 10. The storage 104 is composed of, for example, a hard disk drive (HDD) and a solid state drive (SSD).

The communication I/F 105 is a communication interface based on standards such as Ethernet (registered trademark), Wi-Fi (registered trademark), and 4G, and is a module for communicating with other devices.

The display device 106 is a liquid crystal display, an organic light emitting diode (OLED) display, or the like that displays moving images, still images, characters, and the like, and is used to present information to a user.

The input device 107 is a keyboard, a pointing device, a button, or the like, and receives an operation by a user. The display device 106 and the input device 107 may be integrally formed as a touch panel.

It should be noted that the hardware configuration illustrated in FIG. 2 is an example, and other devices may be added, or a part of the devices may not be provided. Some devices may be replaced with other devices having similar functions. Further, some functions of the present example embodiment may be provided by other devices via the network NW, or the functions of the present example embodiment may be distributed among a plurality of devices. Thus, the hardware configuration illustrated in FIG. 2 can be changed as appropriate.

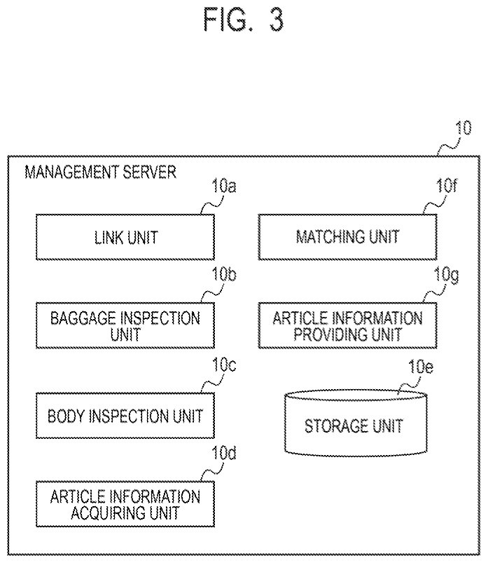

FIG. 3 is a functional block diagram of the management server 10 according to the present example embodiment. The management server 10 includes a link unit 10a, a baggage inspection unit 10b, a body inspection unit 10c, an article information acquiring unit 10d, a storage unit 10e, a matching unit 10f, and an article information providing unit 10g.

The link unit 10a associates the identification information of the user U who has requested entry into the departure area (restricted area) with the identification information of the baggage possessed by the user U. As identification information of the user U, biometric information, a passport number, a reservation number, and the like are used.

The baggage inspection unit 10b performs a baggage inspection process based on a learning model which learned in advance a relationship between an image capturing the baggage (for example, an X-ray captured image) by using a baggage inspection device 405 described later and feature information about an article of detection target.

The body inspection unit 10c performs a body inspection process based on a learning model which learned in advance a relationship between an image captured the body of the user U by using a body inspection device 406 described later (or measured value) and feature information about an article of detection target.

The article information acquiring unit 10d acquires the article information indicating the article included in the baggage of the user U (passenger) in the security inspection of the first country. The article information includes information on an article (target article) which is permitted to be carried into an airplane used by a passenger for the travel and which is restricted to be carried into the second country.

The article information may include any article information included in the baggage. In order to shorten the processing time, the article information may be limited to only articles corresponding to the prohibited/restricted article and the target item among items included in the baggage item.

The storage unit 10e stores information used in each unit of the management server 10, such as user information, article information, learning models, and processing results. The matching unit 10f performs matching processing between the acquired biometric information of the user U and the biometric information registered in the user information DB 11, and outputs the matching result.

The article information providing unit 10g provides article information indicating articles included in the baggage of the user U (passenger) to the device used for the procedure for the entry of the user U to the second country. The procedure for entry includes at least one of a custom inspection procedure, a quarantine procedure, and an entry examination procedure.

The CPU 101 loads a program stored in the ROM 103, the storage 104, or the like into the RAM 102 and executes the program, thereby performing predetermined arithmetic processing. The CPU 101 controls each unit of the management server 10, such as the communication I/F 105, based on the program. Thus, the CPU 101 realizes functions of the link unit 10a, the baggage inspection unit 10b, the body inspection unit 10c, the article information acquiring unit 10d, the storage unit 10e, the matching unit 10f, the article information providing unit 10g, and the like.

Note that some or all of the functions of the functional blocks described in the management server 10 in FIG. 3 may be provided in an external device of the management server 10. That is, each function described above may be realized by the management server 10 alone, or may be realized by cooperation with an external device.

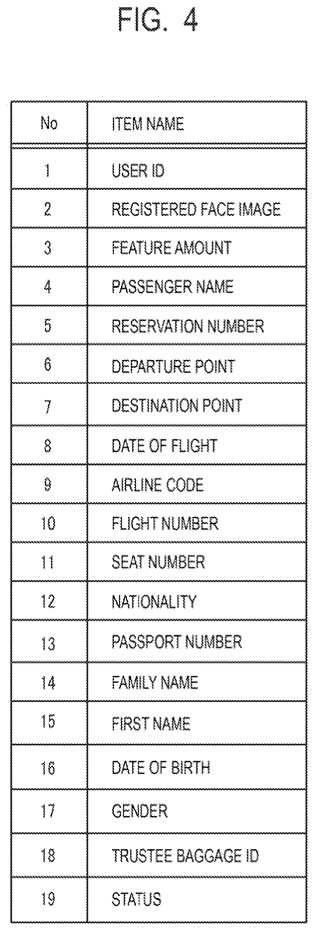

FIG. 4 is a diagram illustrating an example of information stored in the user information DB 11. The user information DB 11 includes, as data items, a user ID, a registered face image, a feature amount, a passenger name, a reservation number, a departure point, a destination point, a date of flight, an airline code, a flight number, a seat number, a nationality, a passport number, a family name, a first name, a date of birth, a gender, a trustee baggage ID, and a status. These data items are merely examples, and other data items may be further included.

The user ID is an identifier uniquely identifying the user U. In the present example embodiment, it is assumed that the user ID is issued on condition that the matching result between the face image of the user U holding the passport at the touch point P1 and the passport face image read from the passport is successful.

The registered face image is a face image registered for the user U. The registered face image is preferably registered based on consent from the user U and deleted at a predetermined timing. The feature amount is a value extracted from the biometric information (registered face image). The phrase of the biometric information in the present example embodiment means a face image and a feature amount extracted from the face image, but the biometric information is not limited to the face image and the face feature amount. That is, biometric authentication may be performed using an iris image, a fingerprint image, a palm print image, an auricle image, or the like as biometric information of the user U.

The reservation number is an identifier uniquely identifying boarding reservation information. The airline code is an identifier that uniquely identifies an airline company. Among the user information illustrated in FIG. 4, examples of the boarding reservation information include a passenger name, a reservation number, a departure point, a destination point, an airline code, a flight number, a date of flight, a seat number, a nationality, a passport number, a family name, a first name a date of birth, a gender, and a trustee baggage ID. The boarding reservation information can be acquired from a medium such as a passport or a boarding ticket. Further, the boarding reservation information can be acquired from a system (not illustrated) of an airline by using a passport number or a reservation number as a key. The trustee baggage ID is an identifier that uniquely identifies the trustee baggage. The status is information indicating the progress of the procedure at the touch points P1 to P7.

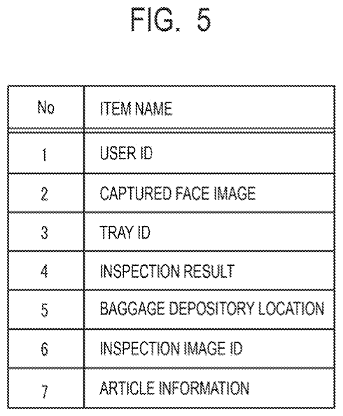

FIG. 5 is a diagram illustrating an example of information stored in the first baggage inspection information DB 12. The first baggage inspection information DB 12 is a database for storing information on baggage inspection for the carry-on baggage. The first baggage inspection information DB 12 includes, as data items, a user ID, a captured face image, a tray ID, an inspection result (pre-inspection/normal/error), a baggage depository location, an inspection image ID, and article information. These data items are merely examples, and other data items may be further included.

The article information preferably includes, for example, information such as classifications (1) to (N) to which the detected article belongs, detection sections (1) to (N), and the quantity of each article (1) to (N). Examples of the section include spray cans, chemicals, fires, knives, machines, animals, plants, plant seeds, foods, noble metals, and alcoholic drinks. Examples of the detection section include a prohibited article, a first restricted article, a second restricted article, a target article, and other articles.

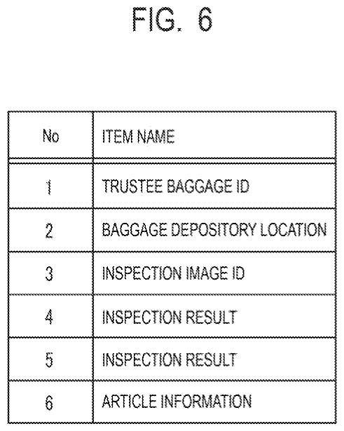

FIG. 6 is a diagram illustrating an example of information stored in the second baggage inspection information DB 13. The second baggage inspection information DB 13 is a database for storing information on baggage inspection for the trustee baggage. The second baggage inspection information DB 13 includes the trustee baggage ID, the baggage depository location, the inspection image ID, the inspection result (pre-inspection/normal/error), and the article information as data items. These data items are merely examples, and other data items may be further included.

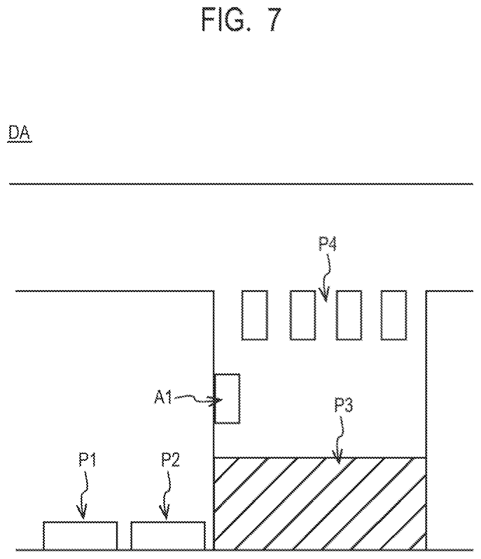

FIG. 7 is a layout diagram illustrating an example of a departure area of an airport DA in the first country. As illustrated in FIG. 7, a check-in counter (touch point P1), a baggage counter (touch point P2), a security inspection site (touch point P3), a custom inspection site A1, and a departure examination site (touch point P4) are arranged in the departure area. When the user U passes through the touch points P1 to P4, the user U moves to a restriction area of the boarding gate (touch point P5). Among the users U that have passed through the security inspection site, the user who purchased the article in the tax-free shop is obliged to perform procedures such as presentation of the passport in the custom inspection site A1.

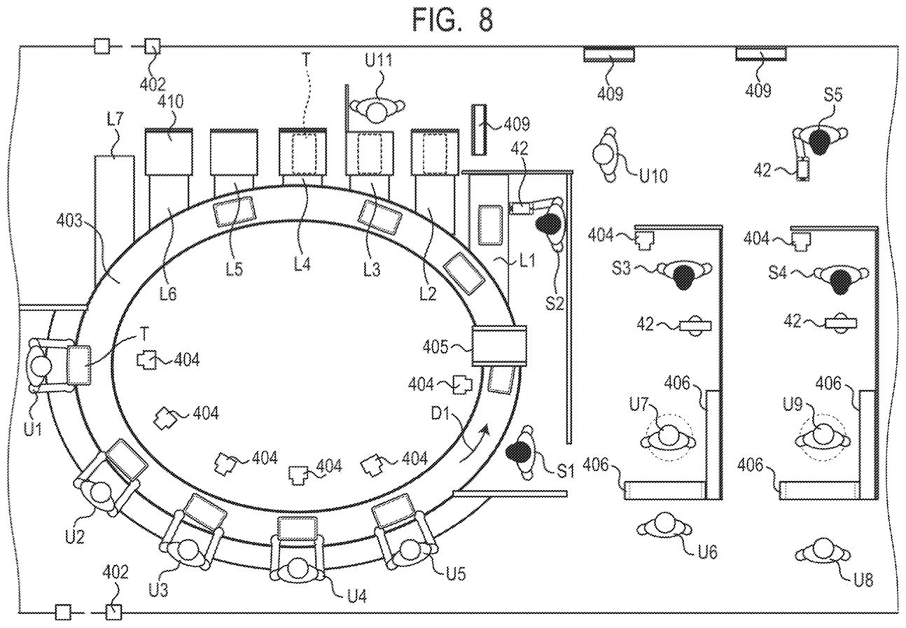

FIG. 8 is a schematic diagram illustrating an example of a security inspection site. A passage control device 402 is provided at an entrance and an exit of the security inspection site (touch point P3). The passage control device 402 determines whether or not the user U is allowed to pass. The passage control device 402 preferably includes, for example, a biometric information acquiring device, a medium reading device, and a gate.

The passage control device 402 transmits the face image captured by the biometric information acquiring device to the management server 10, and requests an authentication process as to whether or not the user U is a person who registers the face image. When the user U is authenticated as a registrant of the face image in the management server 10, the passage control device 402 opens the gate and permits the user U to enter the security inspection site. For the user U whose face image is not registered, the passage control device 402 reads the stored information of the IC chip of the passport using the medium reading device, and determines whether or not the user U is allowed to pass the gate. The plurality of users U1 to U11 illustrated in FIG. 8 are people who are permitted to pass to the security inspection site.

On the left side in the drawing, a baggage inspection site is provided. The baggage inspection area includes a baggage conveyance device 403, a baggage inspection device 405, and a deposition box 410.

The baggage inspection device 405 is a device that inspects, in a non-contact manner, whether or not a prohibited article, a first restricted article, a second restricted article, and a target article (Hereinafter, they are collectively referred to as “target article or the like”.) are included in the baggage of the user U. Examples of the baggage inspection device 405 include an X-ray scanner, a CT scanner, and the like that captures a baggage using X-rays and outputs the captured image to the management server 10. As the baggage inspection device 405, a CT scanner capable of capturing a three-dimensional X-ray image is preferably used in order to improve detection accuracy. When the management server 10 receives the captured image from the baggage inspection device 405, the management server 10 determines whether or not a target article or the like is included in the baggage based on, for example, a predetermined learning model.

Five users U1 to U5 illustrated in FIG. 8 are placed on a belt conveyor of the baggage conveyance device 403 in a state in which the baggage is stored in a predetermined conveyance tray T. As a result, the conveyance tray T moves in the direction of the arrow D1. The conveyance tray T containing the baggage is inserted into the baggage inspection device 405. Then, the baggage inspection device 405 and the management server 10 cooperate with each other to perform the baggage inspection on the baggage in the conveyance tray T.

A total of seven lanes of the error lane L1, the normal lanes L2 to L6, and the unclear lane L7 are branched and provided on the downstream side in the conveying direction of the baggage conveyance device 403. The error lane L1 is a re-inspection lane for conveying the baggage in which prohibited/restricted articles that cannot be conveyed into the airplane are detected. A staff S2 is arranged in the error lane L1. The normal lanes L2 to L6 are lanes for conveying the baggage in which no prohibited/restricted articles are detected, and deposition boxes 410 are provided at the destination of the normal lanes L2 to L6. The baggage is automatically stored from the back side of the deposition box 410. The unclear lane L7 is a lane for conveying the conveyance tray T whose owner is unclear.

On the other hand, on the right side in the figure, a body inspection area is provided. The body inspection area is provided with two inspection booths. Each inspection booth is provided with a body inspection device 406, an operation terminal 42, and a camera 404. FIG. 8 illustrates the user U7 and the user U9 undergoing the body inspection with the body inspection device 406.

The body inspection device 406 is a device for inspecting, in a non-contact manner, whether or not the user U has a target article or the like. Examples of the body inspection device 406 include a metal detector, a millimeter wave scanner, and a terahertz wave scanner. The number of types of the body inspection device 406 used in the body inspection is not limited to one. The metal detector is a device for inspecting whether or not the user U is wearing a metal which may become a hazardous object. In an airport facility, a gate type is widely used as a metal detector.

The millimeter wave scanner is, for example, a device that irradiates a millimeter wave to the body of the user U, measures energy of a reflected wave from the body of the user U, and images the body of the user U. The millimeter wave is, for example, an electromagnetic wave having a wavelength of 1 millimeter or more and 10 millimeters or less and a frequency band of about 30 GHz to 300 GHz.

Similarly, the terahertz wave scanner is a device for imaging the body of the user U using the terahertz wave. The terahertz wave is, for example, an electromagnetic wave having a wavelength of 100 micrometers or more and 1 millimeter or less and a frequency band of about 300 GHz to 3 THz. There are two types of millimeter wave scanners and terahertz wave scanners. Two types are a passive type for measuring electromagnetic waves naturally emitted from an object and an active type for measuring reflected waves when the object is irradiated with electromagnetic waves.

A plurality of signage terminals 409 are provided in an area near the exit of the body inspection area. The signage terminal 409 is a display terminal for presenting various kinds of guide information received from the management server 10 to the user U.

For example, the user U10 is a person who has completed the body inspection and stands in front of the signage terminal 409. Upon capturing the face image of the user U10, the signage terminal 409 transmits the captured face image to the management server 10. The signage terminal 409 preferably displays the deposition location of the luggage or the status of the baggage inspection in accordance with the authentication result of the management server 10.

The deposition box 410 deposits the baggage of the user U conveyed by the baggage conveyance device 403. When a face image of each user U is captured, the deposition box 410 transmits the captured face image to the management server 10. When the authentication in the management server 10 succeeds, the deposition box 410 releases the electronic lock. For example, the user U11 indicates that authentication succeeds and the user U11 has taken out user's baggage from the deposition box 410.

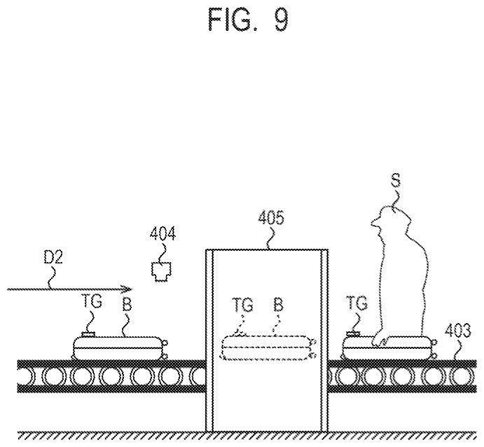

FIG. 9 is a schematic diagram illustrating an example of an inspection area of the trustee baggage. In the inspection area, a baggage conveyance device 403, a camera 404, and a baggage inspection device 405 are provided. In FIG. 9, a plurality of trustee baggage B is placed on the belt conveyor of the baggage conveyance device 403. The trustee baggage B moves in the direction of the arrow D2.

The camera 404 reads the barcode printed on the surface of the tag TG attached to the trustee baggage B before the trustee baggage B arrives at the baggage inspection device 405, and outputs the read information to the management server 10. In the barcode, for example, identification information of the trustee baggage B, a flight name (flight number) of the airplane to which the user U is expected to board, and the like are recorded. Instead of the tag TG on which the barcode is printed, an RFID tag may be used. In this case, a tag reading device may be provided instead of the camera 404.

Thereafter, the trustee baggage B is inserted into the baggage inspection device 405 in accordance with the driving of the belt conveyor. Then, for the trustee baggage B, the baggage inspection is performed by cooperation of the baggage inspection device 405 and the management server 10. When the prohibited/restricted article is detected by the baggage inspection device 405, the staff S re-inspects the trustee baggage B. On the other hand, when the prohibited/restricted article (especially the articles (A) and (B) described above) is not detected by the baggage inspection, the trustee baggage B is automatically conveyed to a deposition location associated with the flight name of the airplane.

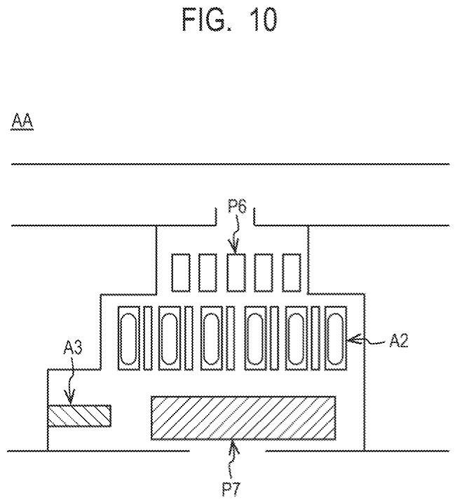

FIG. 10 is a layout diagram illustrating an example of an entrance area of an airport AA in the second country. As illustrated in FIG. 10, an entry examination area (touch point P6), a baggage receiving site A2, a quarantine site A3, and a custom inspection site (touch point P7) are arranged in the entrance area. When the user U completes the entry examination procedure in the entry examination site, the user U receives the trustee baggage in the baggage receiving site A2 and moves to the custom inspection site. When the user U completes the procedure in the custom inspection site, the user U can enter the second country. However, when the user U carries an article such as an animal, a plant, or a food in the second country, it is necessary to separately perform a procedure in the quarantine site A3 before the procedure in the custom inspection site.

Next, the operation of the information processing system 1 according to the present example embodiment will be described with reference to the drawings.

### <Association of User and Baggage>

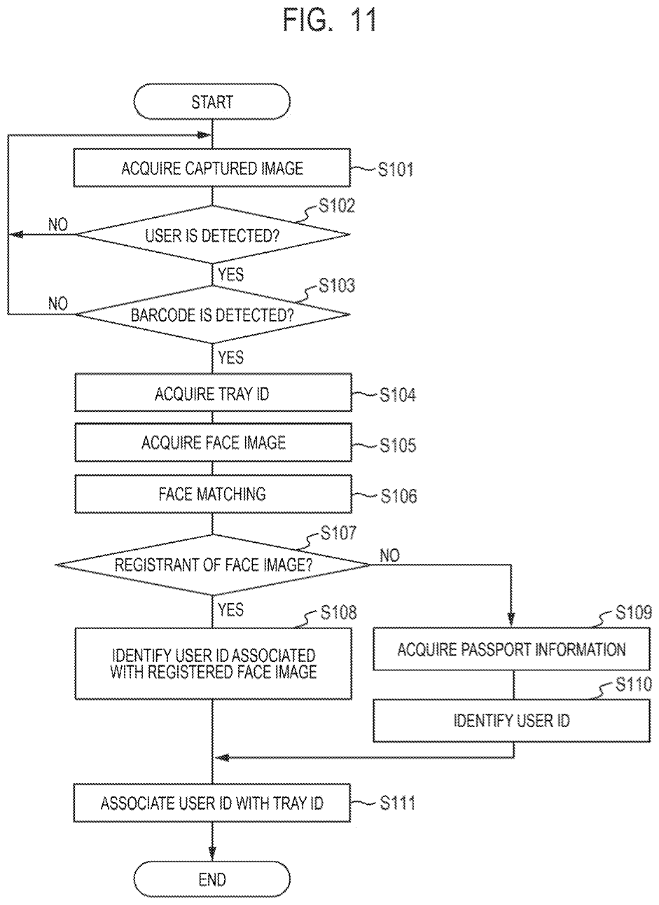

FIG. 11 is a flowchart illustrating an example of processing of the information processing system 1. This process is performed to associate the user U, which is the owner of the baggage, with the baggage when the user U undergoes the inspection of the carry-on baggage in the security inspection site.

First, the management server 10 acquires an image captured by the camera 404 (step S101). Next, when the management server 10 determines that the user U, which is the subject of the security inspection, is detected in the captured image acquired (YES in step S102), the process proceeds to step S103.

On the other hand, when the management server 10 determines that the user U has not been detected in the captured image acquired (NO in step S102), the process returns to the step S101.

Next, when the management server 10 determines that a predetermined barcode attached to the surface of the conveyance tray has been detected from the captured image (YES in step S103), the process proceeds to step S104.

On the other hand, when the management server 10 determines that the predetermined barcode attached to the surface of the conveyance tray is not detected from the captured image (NO in step S103), the process returns to the step S101. That is, the processes of steps S101 to S103 are repeated until a captured image in which the barcode of the user U (the subject) and the barcode of the conveyance tray are displayed together is acquired.

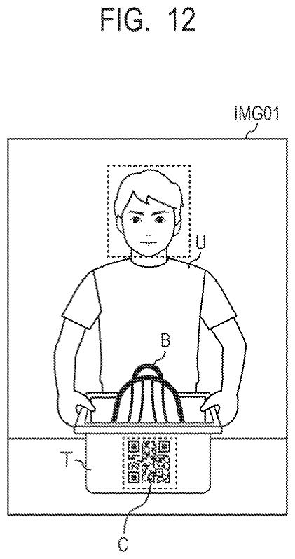

FIG. 12 is a diagram illustrating an example of an image captured at the start of the security inspection. Here, a captured image IMG01 captured when the user U deposits the baggage B in the conveyance tray T is illustrated. A barcode C indicating a tray ID is printed on the surface of the conveyance tray T. In this way, the face image (biometric information) of the user U and the identification information of the conveyance tray T are simultaneously acquired from one captured image IMG01, and link information for associating the user U and the conveyance tray T (that is, the baggage B) is created. When the user U deposits the baggage B separately in the plurality of conveyance trays T, a plurality of pieces of link information are created.

Next, the management server 10 decodes the barcode detected in the step S103 to acquire a tray ID for identifying the conveyance tray (step S104).

Next, the management server 10 acquires the face image of the user U from the captured image (step S105) When a plurality of people are included in the same captured image, it is preferable to determine the position relation between people based on the distance between eyes or the like, and to acquire the face image of the person located in front.

Next, the management server 10 performs face matching that matches the face image acquired in the step S105 with the registered face image stored in the user information DB 11 at one-to-N(N is equal to or more than two) (step S106).

Next, when the management server 10 determines that the user U is a person who registers a face image (YES in step S107), the process proceeds to step S108. On the other hand, when the management server 10 determines that the user U is not a person who registers the face image (NO in step S107), the process proceeds to step S109.

In step S108, the management server 10 identifies the user ID of the user U based on the biometric information. Specifically, a user ID associated with a registered face image whose matching result with the face image is matching is identified among the registered face images stored in the user information DB 11.

In step S109, the management server 10 acquires the passport information of the user U. Next, the management server 10 refers to the user information DB 11 based on the passport number included in the passport information to identify the user ID (step S110). The passport information of the user U can be acquired, for example, by reading the passport information with a medium reading device (not illustrated) when the user U stores the baggage in the conveyance tray or when receiving the conveyance tray from the staff S.

Then, the management server 10 registers the user ID, the tray ID, the face image, and the inspection image in the first baggage inspection information DB 12 in association with each other (step S111), and ends the process.

### <Inspection of Carry-on Baggage>

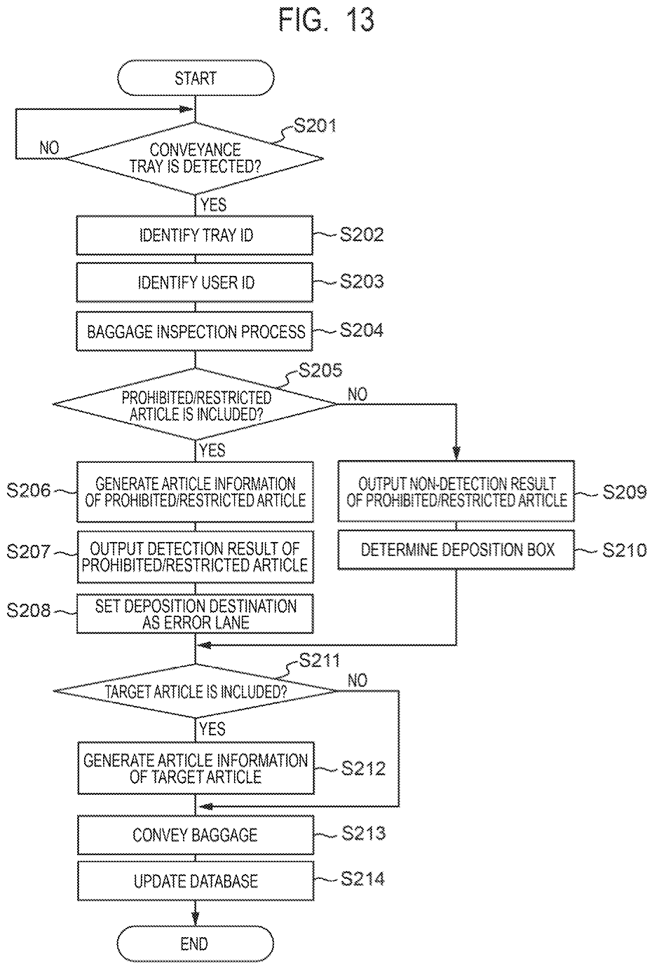

FIG. 13 is a flowchart illustrating an example of an inspection process performed by the information processing system 1 on carry-on baggage. This process is performed, for example, when the carry-on baggage is conveyed to the position of the baggage inspection device 405 by driving the baggage conveyance device 403. In the description of FIG. 13, it is assumed that the “prohibited/restricted article” excludes a first restricted article which is allowed to be carried into an airplane as carry-on baggage.

First, when the management server 10 determines that the conveyance tray moving into the baggage inspection device 405 is detected from the captured image received from the camera 404 installed in the vicinity of the baggage inspection device 405 (YES in step S201), the process proceeds to step S202. On the other hand, when the management server 10 determines that the conveyance tray has not been detected (NO in step S201), the standby state is maintained.

Next, the management server 10 identifies the tray ID of the conveyance tray by image analysis of the captured image acquired from the camera 404 (step S202).

Next, the management server 10 refers to the first baggage inspection information DB 12 using the tray ID as a key to identify the user ID (step S203).

Next, the management server 10 performs a baggage inspection process in cooperation with the baggage inspection device 405 (step S204). Specifically, the management server 10 performs an image analysis process of a captured image (for example, a three-dimensional X-ray image) captured by the baggage inspection device 405.

Next, the management server 10 determines whether or not the prohibited/restricted articles are included in the baggage by the image analysis process (step S205). Here, when the management server 10 determines that the baggage includes prohibited/restricted articles (YES in step S205), the process proceeds to step S206. On the other hand, when the management server 10 determines that the prohibited/restricted articles are not included in the baggage (NO in step S205), the process proceeds to step S209.

In step S206, the management server 10 generates article information of prohibited/restricted articles. The article information of the prohibited/restricted articles includes information on classification, quantity, size, and the like of the article.

Next, the management server 10 outputs the detection result of the prohibited/restricted article to the operation terminal 42 (step S207). Next, the management server 10 sets the deposition destination of the baggage in which the prohibited/restricted article is detected as the error lane (step S208). Then, the process proceeds to step S211.

In step S209, the management server 10 outputs the non-detection result of the prohibited/restricted article to the operation terminal 42. Next, the management server 10 determines a deposition box 410 to be a deposition destination of the baggage (step S210). Then, the process proceeds to step S211.

In step S211, the management server 10 determines whether or not a target article is included in the baggage. Here, when the management server 10 determines that a target article is included in the baggage (YES in step S211), the process proceeds to step S212. On the other hand, when it is determined that the object is not included in the baggage (step S211, NO), the process proceeds to step S213.

In step S212, the management server 10 generates article information of the target article. The article information of the article includes information on classification, quantity, size, and the like of the article.

In step S213, the management server 10 outputs drive control information to the baggage conveyance device 403 so that the baggage is conveyed to the destination (deposition destination) determined in the step S208 or the step S210.

Then, the management server 10 updates the first baggage inspection information DB 12 based on the user ID of the user U and the inspection result of the baggage inspection (step S214), and ends the process.

### <Inspection of Trustee Baggage>

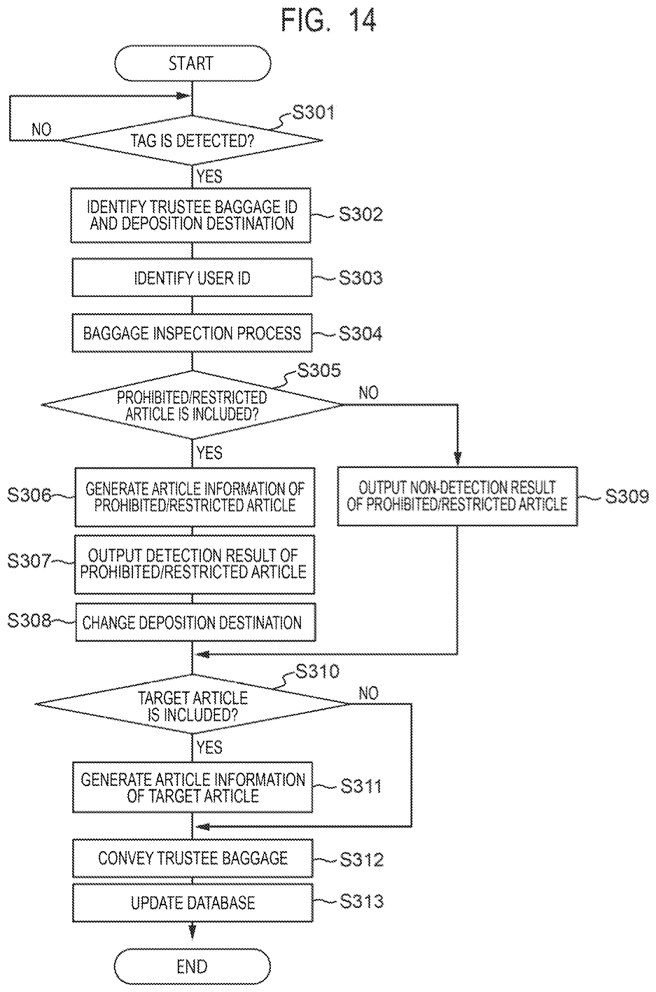

FIG. 14 is a flowchart illustrating an example of the inspection process for the trustee baggage of the information processing system 1. This process is performed, for example, when the trustee baggage is conveyed to the position of the baggage inspection device 405 by the drive of the baggage conveyance device 403. In the description of FIG. 14, it is assumed that the “prohibited/restricted article” excludes a second restricted article which is allowed to be carried into the airplane as trustee baggage.

First, when the management server 10 determines that the tag attached to the trustee baggage is detected from the captured image received from the camera 404 installed in the vicinity of the baggage inspection device 405 (YES in step S301), the process proceeds to step S302. On the other hand, when the management server 10 determines that the tag has not been detected (NO in step S301), the standby state is maintained.

Next, the management server 10 reads the information of the tag included in the captured image, thereby identifying the trustee baggage ID and the deposition destination (step S302).

Next, the management server 10 refers to the user information DB 11 using the trustee baggage ID as a key, and identifies the user ID of the user U who is the owner of the trustee baggage (step S303).

Next, the management server 10 performs a baggage inspection process in cooperation with the baggage inspection device 405 (step S304). Specifically, the management server 10 performs an image analysis process of a captured image (for example, a three-dimensional X-ray image) captured by the baggage inspection device 405.

Next, the management server 10 determines whether or not the prohibited/restricted articles are included in the trustee baggage by the image analysis process (step S305). Here, when the management server 10 determines that the trustee baggage includes the prohibited/restricted article (YES in step S305), the process proceeds to step S306. On the other hand, when the management server 10 determines that the prohibited/restricted article is not included in the trustee baggage (NO in step S305), the process proceeds to step S309.

In step S306, the management server 10 generates article information of prohibited/restricted articles. The article information of the prohibited/restricted article includes information on classification, quantity, size, and the like of the article.

Next, the management server 10 outputs the detection result of the prohibited/restricted article to the operation terminal 42 (step S307). Next, the management server 10 changes the conveyance destination of the deposited baggage (step S308). Specifically, the management server 10 changes the conveyance destination of the trustee baggage from the initial conveyance destination recorded in the tag to the re-inspection site. Then, the process proceeds to step S310. In step S309, the management server 10 outputs the non-detection result of the prohibited/restricted article to the operation terminal 42. Then, the process proceeds to step S310.

In step S310, the management server 10 determines whether or not a target article is included in the trustee baggage. Here, when the management server 10 determines that a target article is included in the trustee baggage (YES in step S310), the process proceeds to step S311. On the other hand, when it is determined that the target article is not included in the baggage (NO in step S310), the process proceeds to step S312.

In step S311, the management server 10 outputs drive control information to the baggage conveyance device 403, and conveys the trustee baggage to the conveyance destination identified in the step S302 or the conveyance destination changed in the step S308.

Then, the management server 10 updates the second baggage inspection information DB 13 based on the trustee baggage ID, the user ID of the user U, and the inspection result of the baggage inspection (step S313) and ends the process.

It is preferable to detect the number of the prohibited/restricted articles and the number of the target articles in the process of FIG. 13 and FIG. 14 in consideration of the case where there is an article having a restriction in the carry-on quantity in the second country. Further, when common articles are included in the carry-on baggage and the trustee baggage of the same person, it is preferable that the quantity of the articles is summed up and stored in the database in association with the user ID. The database storing the information may be any one of the user information DB 11, the first baggage inspection information DB 12, and the second baggage inspection information DB 13, or may be another database.

### <Entry Examination Procedure (1)>

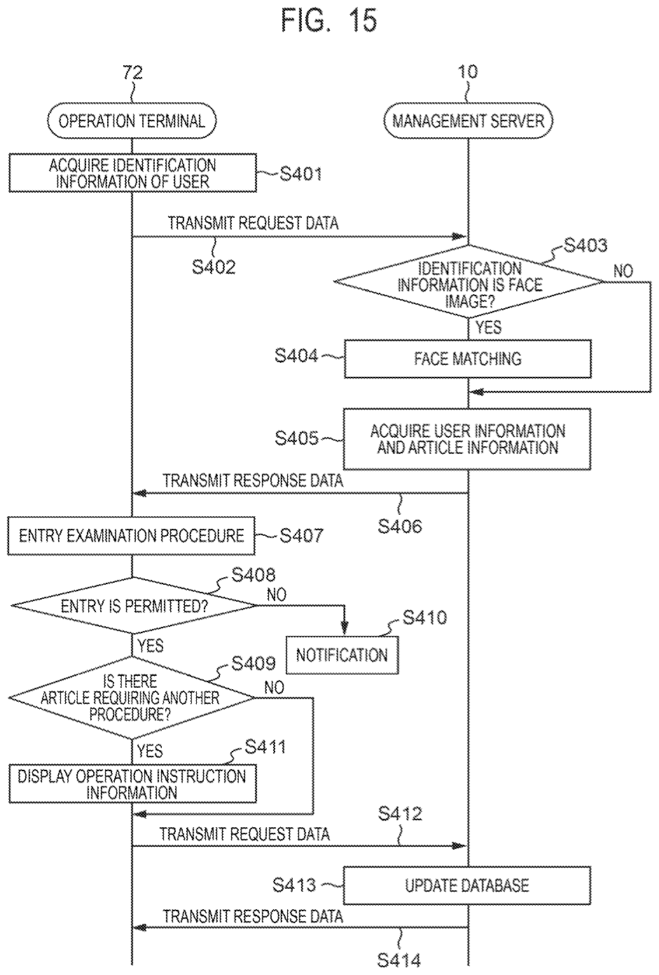

FIG. 15 is a sequence chart illustrating an example of process at the time of an entry examination procedure of the information processing system 1. This process is performed when the user U arriving in the second country undergoes the entry examination procedure by the manned counter in which the staff S exists.

First, the operation terminal 72 acquires identification information of the user U based on an operation of the staff S (step S401). Here, the identification information of the user U is a face image (biometric information) of the user U or a passport number read from a medium such as a passport. The biometric information stored in the IC chip of the passport can also be used as the identification information of the user U.

Next, the operation terminal 72 transmits the request data to the management server 10 (step S402). The request data includes identification information of the user U and a request to transmit the user information and the article information. When a face image (biometric information) is acquired as identification information of the user U, the face image data is included.

When receiving the request data from the operation terminal 72, the management server 10 determines whether or not the identification information of the user U included in the request data is a face image (step S403). When the management server 10 determines that the identification information of the user U is a face image (YES in step S403), the process proceeds to step S404. On the other hand, when the management server 10 determines that the identification information of the user U is the passport number (NO in step S403), the process proceeds to step S405.

In step S404, the management server 10 performs face matching of the user U. That is, the management server 10 performs one-to-N matching between the target face image received from the operation terminal 72 and a plurality of registered face images registered in the user information DB 11.

In step S405, the management server 10 refers to the user information DB 11, and acquires the user information and the article information. Next, the management server 10 transmits the response data including the user information and the article information to the operation terminal 72 (step S406).

In step S407, the operation terminal 72 performs an entry examination procedure based on the response data received from the management server 10 and the operation of the staff S. Next, the operation terminal 72 determines whether or not the entry of the user U is permitted (step S408).

Here, when the operation terminal 72 determines that the entry of the user U is permitted (YES in step S408), the process proceeds to step S409. On the other hand, when the operation terminal 72 determines that the entry of the user U is not permitted (NO in step S408), the operation terminal 72 notifies the error information (step S410).

In step S409, the operation terminal 72 determines whether or not there is an article requiring another procedure in the baggage of the user U based on the article information included in the response data. Specifically, the operation terminal 72 performs determination process by comparing the list of articles that are prohibited or restricted by the laws and regulations of the second country with the article information provided from the management server 10.

Here, when the operation terminal 72 determines that there is an article requiring another procedure (YES in step S409), the operation instruction information is displayed (step S411), and the process proceeds to step S412.

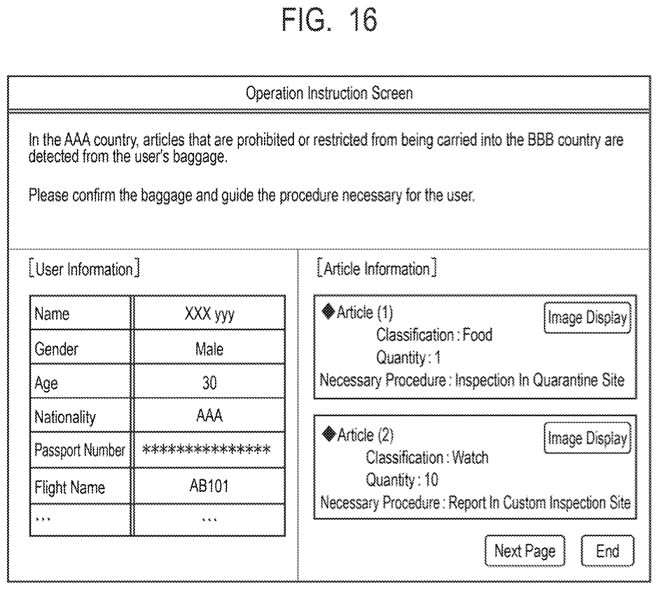

FIG. 16 is a diagram illustrating an example of a screen displayed on the operation terminal 72. Here, the screen includes the following message of an operation instruction for the staff S. “In the AAA country, articles that are prohibited or restricted from being carried into the BBB country are detected from the user's baggage. Please confirm the baggage and guide the procedure necessary for the user.” The screen includes user information of the user U, and article information. The operation instruction screen may further display a face image of the user U or a face image of a passport.

On the other hand, when the operation terminal 72 determines that there are no articles requiring other procedures (NO in step S409), the process proceeds to step S412.

In step S412, the operation terminal 72 transmits the request data to the management server 10. The request data includes a user ID, a result of an entry examination procedure, and a database update request.

Next, when receiving the request data from the operation terminal 72, the management server 10 updates the user information DB 11 (step S413). Specifically, the management server 10 updates the status of the user information DB 11 to “entry examination procedure completion” using the user ID as a key.

Then, the management server 10 transmits the response data including the process result to the operation terminal 72 (step S414), and ends the process.

### <Entry Examination Procedure (2)>

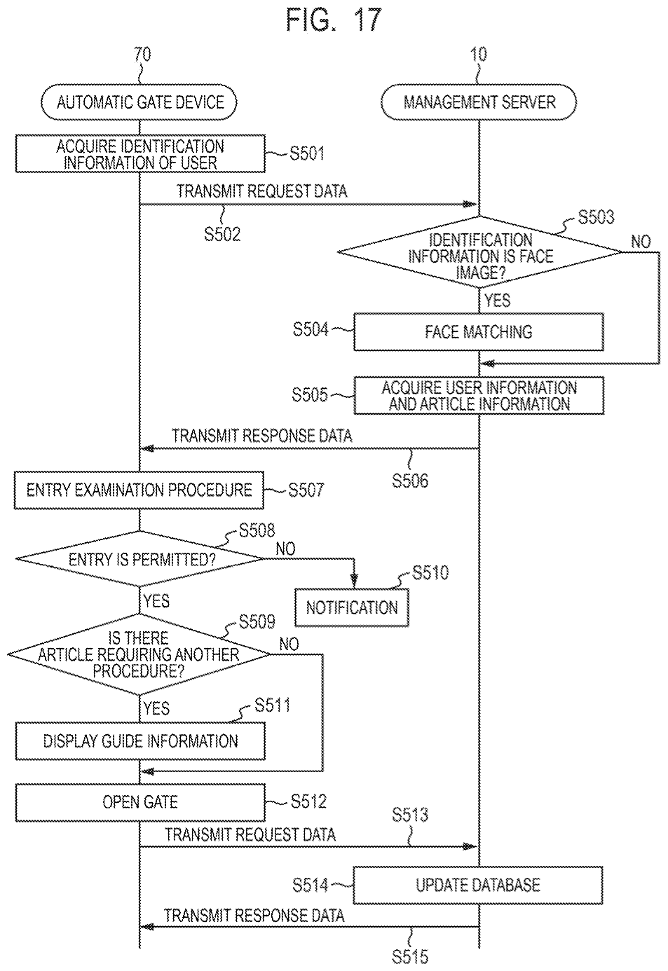

FIG. 17 is a sequence chart illustrating an example of a process performed by the information processing system 1 at the time of entry examination. This process is performed when the user U arriving in the second country undergoes an entry examination procedure in the automatic gate device 70.

First, the automatic gate device 70 acquires identification information of the user U (step S501). Here, the identification information of the user U is a face image (biometric information) of the user U or a passport number read from a medium such as a passport. The biometric information recorded in the IC card of the passport can also be used as the identification information of the user U.

Next, the automatic gate device 70 transmits the request data to the management server 10 (step S502). The request data includes identification information of the user U and a request to transmit the user information and the article information. When a face image (biometric information) is acquired as identification information of the user U, the face image data is included.

When receiving the request data from the automatic gate device 70, the management server 10 determines whether or not the identification information of the user U included in the request data is a face image (step S503).

When the management server 10 determines that the identification information of the user U is a face image (YES in step S503), the process proceeds to step S504. On the other hand, when the management server 10 determines that the identification information of the user U is the passport number (NO in step S503), the process proceeds to step S505.

In step S504, the management server 10 performs face matching of the user U. That is, the management server 10 performs one-to-N matching between the target face image received from the automatic gate device 70 and a plurality of registered face images registered in the user information DB 11.

In step S505, the management server 10 acquires user information and article information. Next, the management server 10 transmits the response data including the user information and the article information to the automatic gate device 70 (step S506).

In step S507, the automatic gate device 70 automatically performs an entry examination procedure based on the response data received from the management server 10. Next, the automatic gate device 70 determines whether the entry of the user U is permitted (step S508).

Here, when the automatic gate device 70 determines that the entry of the user U is permitted (YES in step S508), the process proceeds to step S509. On the other hand, when the automatic gate device 70 determines that the entry of the user U is not permitted (NO in step S508), the automatic gate device 70 notifies the error information (step S510).

In step S509, the automatic gate device 70 determines whether or not there is an article requiring another procedure in the baggage of the user based on the article information included in the response data. Here, when the automatic gate device 70 determines that there is an article requiring another procedure (YES in step S509), guide information for the user U is displayed (step S511), and the process proceeds to step S512.

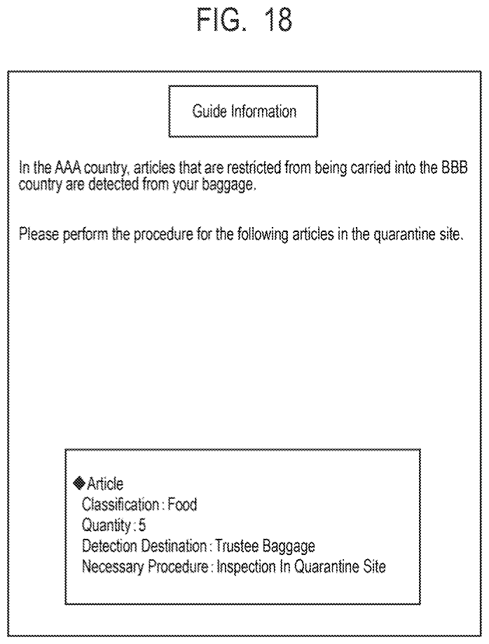

FIG. 18 is a diagram illustrating an example of a screen displayed on the automatic gate device 70. Here, the screen includes the following message to guide a procedure necessary for carrying the article to the user U and the article information. “In the AAA country, articles that are restricted from being carried into the BBB country are detected from your baggage. Please perform the procedure for the following articles in the quarantine site.”.

On the other hand, when the automatic gate device 70 determines that there are no articles requiring other procedures (NO in step S509), the process proceeds to step S512.

In step S512, the automatic gate device 70 opens the gate. Next, the automatic gate device 70 transmits the request data to the management server 10 (step S513). The request data includes a user ID, a result of an entry examination procedure, and a database update request.

Next, when receiving the request data from the automatic gate device 70, the management server 10 updates the user information DB 11 (step S514). Specifically, the management server 10 updates the status of the user information DB 11 to “entry examination procedure completion” using the user ID as a key.

Then, the management server 10 transmits the response data including the process result to the automatic gate device 70 (step S515), and ends the process.

### <First Custom Inspection Procedure>

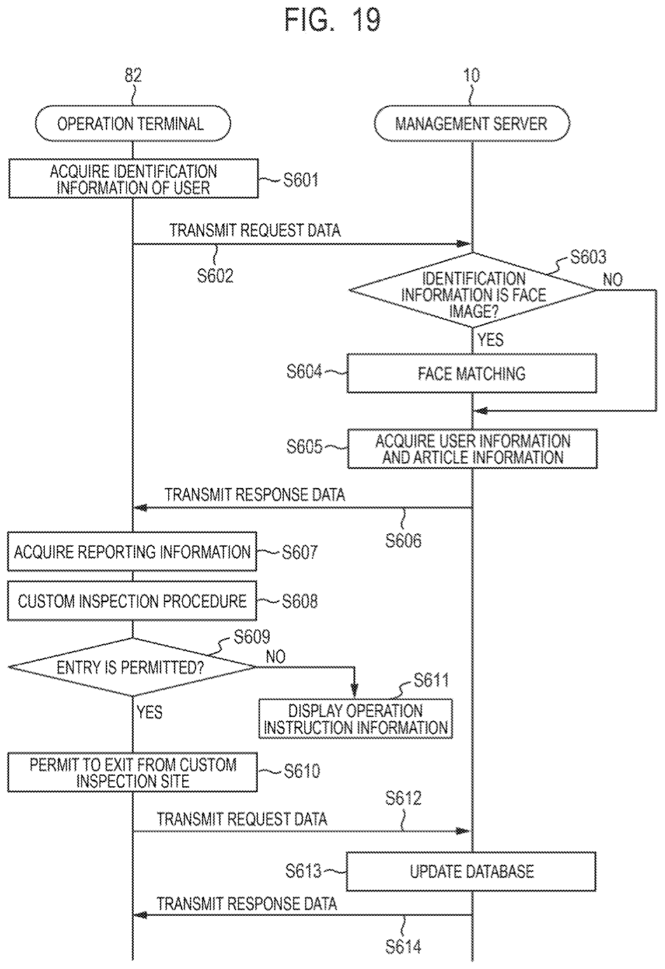

FIG. 19 is a sequence chart illustrating an example of a process at the time of custom inspection of the information processing system 1. This process is performed when the user U who has completed the entry examination procedure undergoes the custom inspection procedure in the manned counter in which the staff S exists.

First, the operation terminal 82 acquires identification information of the user U (step S601). Here, the identification information of the user U is a face image (biometric information) of the user U or a passport number read from a medium such as a passport. The biometric information recorded in the IC card of the passport can also be used as the identification information of the user U.

Next, the operation terminal 82 transmits the request data to the management server 10 (step S602). The request data includes identification information of the user U and a request to transmit the user information and the article information. When a face image (biometric information) is acquired as identification information of the user U, the face image data is included.

When receiving the request data from the operation terminal 82, the management server 10 determines whether or not the identification information of the user U included in the request data is a face image (step S603).

Here, when the management server 10 determines that the identification information of the user U is a face image (YES in step S603), the process proceeds to step S604. On the other hand, when the management server 10 determines that the identification information of the user U is the passport number (NO in step S603), the process proceeds to step S605.

In step S604, the management server 10 performs face matching of the user U. That is, the management server 10 performs one-to-N matching between the target face image received from the operation terminal 82 and a plurality of registered face images registered in the user information DB 11.

In step S605, the management server 10 acquires user information and article information. Next, the management server 10 transmits the response data including the user information and the article information to the operation terminal 82 (step S606). Next, the operation terminal 82 acquires report information of the user U (step S607).

In step S608, the operation terminal 82 automatically performs a custom inspection procedure based on the response data received from the management server 10. Next, the operation terminal 82 determines whether or not the entry of the user U is permitted (step S609). Specifically, based on the article information included in the response data, the operation terminal 82 determines whether or not there is an article requiring another procedure in the baggage of the user.

Here, when the operation terminal 82 determines that the entry of the user U is permitted (YES in step S609), the process proceeds to step S610. On the other hand, when the operation terminal 82 determines that the entry of the user U is not permitted (NO in step S609), the operation terminal 82 displays the operation instruction information (step S611).

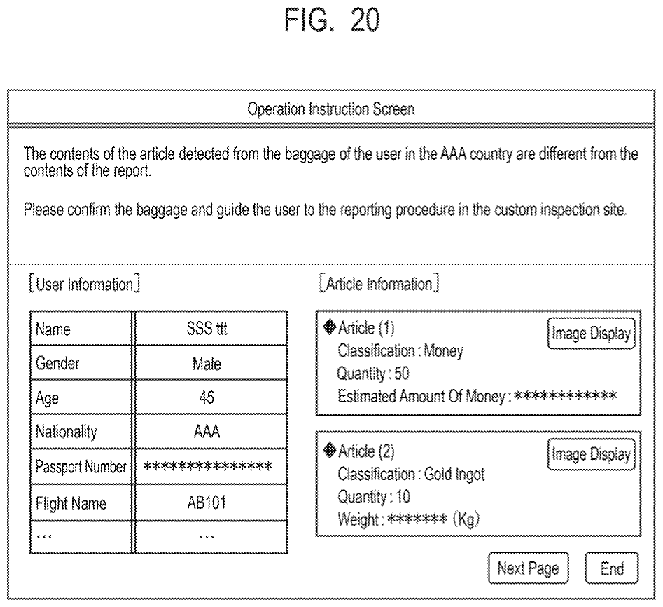

FIG. 20 is a diagram illustrating an example of a screen displayed on the operation terminal 82. Here, the screen includes the following message of an operation instruction for the staff S. “The contents of the article detected from the baggage of the user in the AAA country are different from the contents of the report. Please confirm the baggage and guide the user to the reporting procedure in the custom inspection site.” The screen includes user information of the user U, and article information. The operation instruction screen may further display a face image of the user U or a face image of a passport.

In step S610, the operation terminal 82 permits the user U to exit from the custom inspection site. Next, the operation terminal 82 transmits the request data to the management server 10 (step S612). The request data includes a user ID, results of a custom inspection procedure, and a database update request.

Next, when receiving the request data from the operation terminal 82, the management server 10 updates the user information DB 11 (step S613). Specifically, the management server 10 updates the status of the user information DB 11 to “completion of the custom inspection procedure” using the user ID as a key.

Then, the management server 10 transmits the response data including the process result to the operation terminal 82 (step S614), and ends the process.

### <Second Custom Inspection Procedure>

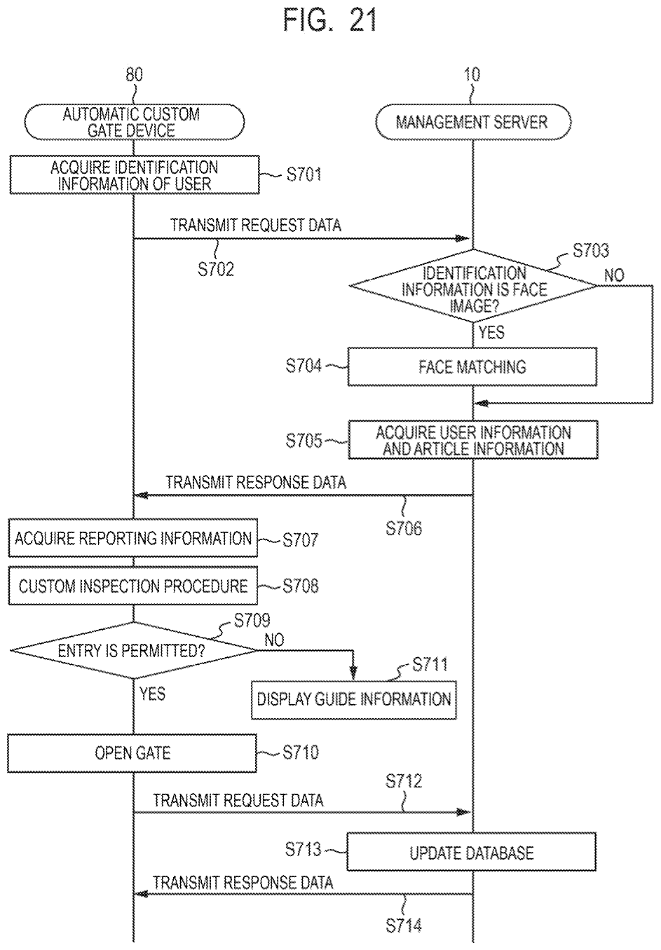

FIG. 21 is a sequence chart illustrating an example of a process at the time of custom inspection of the information processing system 1. This process is performed when the user U who has completed the entry examination procedure undergoes the custom inspection procedure in the automatic custom gate device 80.

First, the automatic custom gate device 80 acquires identification information of the user U (step S701). Here, the identification information of the user U is a face image (biometric information) of the user U or a passport number read from a medium such as a passport. The biometric information recorded in the IC card of the passport can also be used as the identification information of the user U.

Next, the automatic custom gate device 80 transmits the request data to the management server 10 (step S702). The request data includes identification information of the user U and a request to transmit the user information and the article information. When a face image (biometric information) is acquired as identification information of the user U, the face image data is included.

When receiving the request data from the automatic custom gate device 80, the management server determines whether or not the identification information of the user U included in the request data is a face image (step S703).

Here, when the management server 10 determines that the identification information of the user U is a face image (YES in step S703), the process proceeds to step S704. On the other hand, when the management server 10 determines that the identification information of the user U is the passport number (step S703, NO), the process proceeds to step S705.

In step S704, the management server 10 performs face matching of the user U. That is, the management server 10 performs one-to-N matching the target face image received from the automatic custom gate device 80 and a plurality of registered face images registered in the user information DB 11.

In step S705, the management server 10 acquires user information and article information. Next, the management server 10 transmits the response data including the user information and the article information to the automatic custom gate device 80 (step S706).

Next, when the automatic custom gate device 80 acquires the report information input from the user U (step S707), the automatic custom gate device 80 automatically performs the custom inspection procedure based on the response data received from the management server 10 (step S708). Next, the automatic custom gate device 80 determines whether or not the country of the user U is permitted (step S709). Specifically, the automatic custom gate device 80 determines whether or not there is an article requiring another procedure in the baggage of the user based on the article information included in the response data.

Here, when the automatic custom gate device 80 determines that the entry of the user U is permitted (YES in step S709), the process proceeds to step S710. On the other hand, when the automatic custom gate device 80 determines that the entry of the user U is not permitted (NO in step S709), the automatic custom gate device 80 displays guide information (step S711).

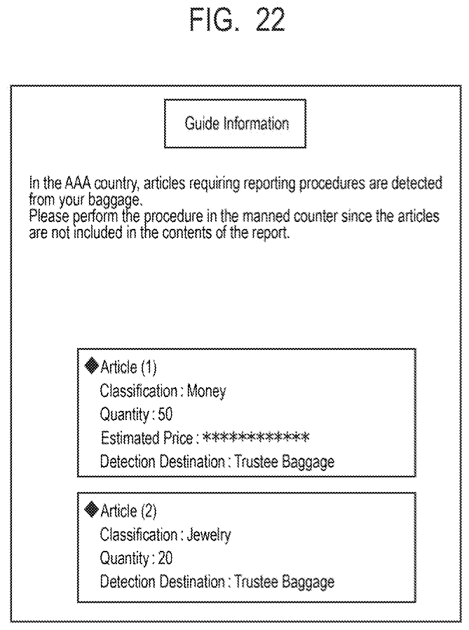

FIG. 22 is a diagram illustrating an example of a screen displayed on the automatic custom gate device 80. Here, the screen includes the following message to guide a procedure necessary for carrying the article to the user U and the article information. “In the AAA country, articles requiring reporting procedures are detected from your baggage. Please perform the procedure in the manned counter since the articles are not included in the contents of the report.”

In step S711, the automatic custom gate device 80 may not only display the guide information as illustrated in FIG. 22, but also perform the following process.

(A) Without opening the gate, it is instructed to move to the entrance side of the automatic custom gate device 80.
(B) After instructing the user U to correct the contents of the report, the user U instructs the user U to return to the manned counter (face-to-face examination).
(C) An alert is notified to the operation terminal 82 carried by the staff S of the custom inspection site. On the display screen of the alert, the position of the gate, the number of the gate, the face image of the target user U, and the like are displayed together with the information included in the screen of FIG. 22.

In step S710, the automatic custom gate device 80 opens the gate. Next, the automatic custom gate device 80 transmits the request data to the management server 10 (step S712). The request data includes a user ID, results of a custom inspection procedure, and a database update request.

Next, when receiving the request data from the automatic custom gate device 80, the management server 10 updates the user information DB 11 (step S713). Specifically, the management server 10 updates the status of the user information DB 11 to “completion of the custom inspection procedure” using the user ID as a key.

Then, the management server 10 transmits the response data including the process result to the automatic custom gate device 80 (step S714), and ends the process.

As described above, the information processing system 1 (management server 10) of the present example embodiment acquires the article information indicating the article included in the baggage of the passenger in the security inspection of the first country, and provides the article information to the device used in the procedure for the entry into the second country of the passenger. Thereby, in the second country, it is possible to efficiently execute the procedure for the entry person (user U).

The article information provided by the management server 10 to the devices in the second country includes information on articles which are permitted to be carried into the transportation equipment used by the passage for the travel and which are restricted to be carried into the second country. As a result, in the procedure of the second country, it is possible to easily determine whether or not the entry person (user U) is attempting to carry a predetermined article into the country.

The article information includes information on the quantity of each article. Thus, in the second country, it is possible to efficiently perform a procedure for an article having a restriction on the carry-on quantity.

In the present example embodiment, the management server 10 is configured to acquire the article information detected by the baggage inspection for each of the carry-on baggage and the trustee baggage, and to provide the article information to the device in the second country. This makes it possible to reliably determine whether the user U has a target article in the second country.

The management server 10 can provide the article information to both the devices (the operation terminal 72 and the operation terminal 82) operated by the staff S in the procedure for the country and the devices (the automatic gate device 70 and the automatic custom gate device 80) that automatically perform the procedure. Thereby, the management server 10 can efficiently perform the procedure regardless of whether the user U selects the procedure method of the interaction-format with the staff S or the self-format.

According to the present example embodiment, it is possible to grasp in advance the number of users U who should perform the reporting procedure in the custom inspection site of the second country. It is preferable that the number of corresponding users (occupants) U can be grasped for each flight or for each time. For example, among 200 passengers of the NH01 flight arriving at the airport AA at 14 o'clock, if 30 passengers need to perform a reporting procedure in a custom inspection site, information of the corresponding passenger can be grasped in advance (for example, before an airplane arrives at the airport AA). Similarly, if 100 passengers among 1000 passengers arriving at the airport AA in the time zone from 14 o'clock to 15 o'clock need to perform a reporting procedure in the custom inspection site, the information can be grasped in advance. In this way, since the person who needs to perform the reporting procedure in the custom inspection site can be grasped in advance, the placement of the custom personnel can be optimized.

Further, according to the present example embodiment, in a case where a person who needs to perform a reporting procedure in a custom inspection site attempts to pass through the custom inspection site without reporting, it is possible to detect the person and restrict the passage of the person. For example, in the case where three people among the 30 people requiring a reporting procedure in the custom inspection site attempt to pass through the custom inspection site without reporting, it is possible to restrict the passage of the three persons.

### Second Example Embodiment

The information processing system 2 (management server 10) of the present example embodiment is different from that of the first example embodiment in that the information processing system 2 (management server 10) further includes a function of providing information about a target article to a user U before the travel in the examination procedure in the first country. In the present example embodiment, the description of the same portions as those described in the first example embodiment may be omitted or simplified.

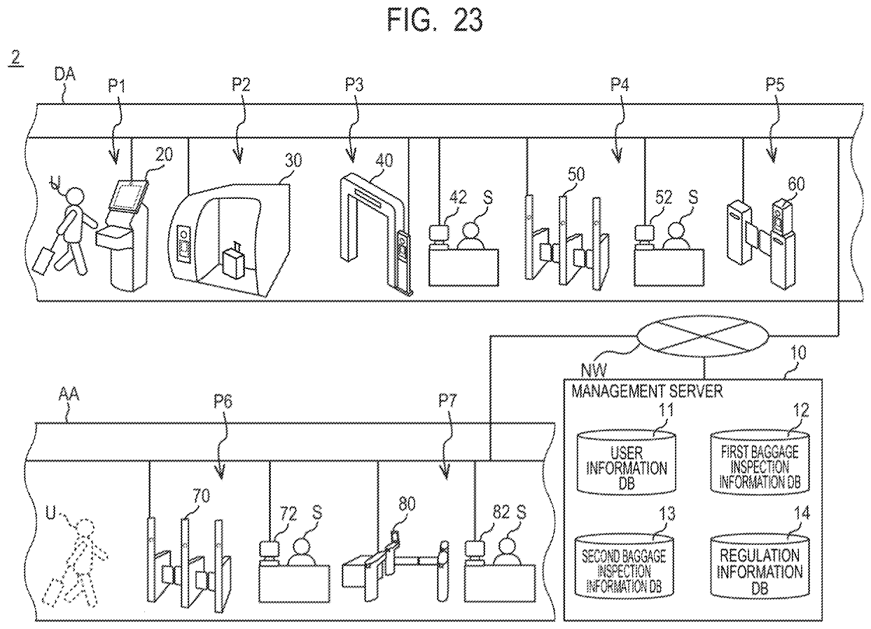

FIG. 23 is a schematic diagram illustrating an example of a general configuration of the information processing system 2 according to the present example embodiment. As illustrated in FIG. 23, the management server 10 of the present example embodiment further includes a regulation information DB 14.

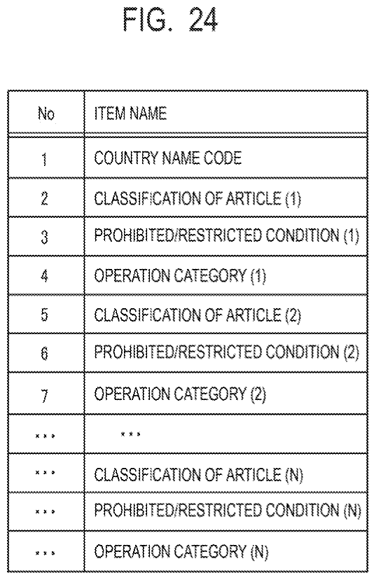

FIG. 24 is a diagram illustrating an example of information stored in the regulation information DB 14. The regulation information DB 14 is a database that stores regulation information on articles whose carrying of articles into the country is prohibited or restricted for each country.

The regulation information DB 14 includes, as data items, country name codes unique to each country, classifications (1) to (N) to which articles belong, prohibited/restricted conditions (1) to (N) for carrying articles, and operation categories at the time of carrying. The classifications (1) to (N) of the articles are preferably defined according to regulations applied to the articles in the second country. Specific examples of the prohibited/restricted condition include a quantity, an amount, and a weight. Specific examples of the operation category at the time of carrying are quarantine, custom reporting, immersion/discard, penalty, and the like. These data items are merely examples, and other data items may be further included.

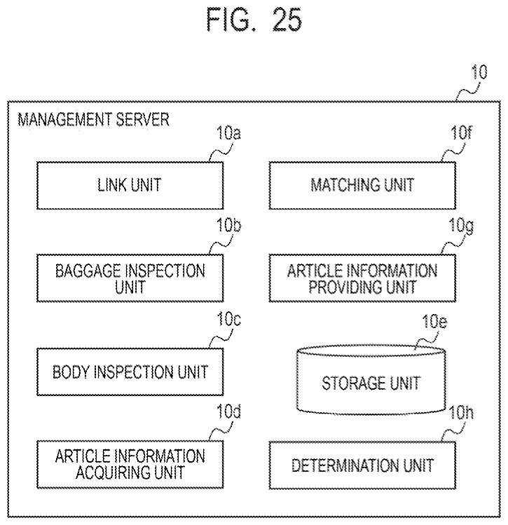

FIG. 25 is a functional block diagram of the management server 10 according to the present example embodiment. As illustrated in FIG. 25, the management server 10 of the present example embodiment further includes a determination unit 10h. The determination unit 10h determines whether or not a target article at a travel destination is included in the baggage based on the article information about the baggage of the user U and the regulation information at the travel destination stored in the storage unit 10e (the regulation information DB 14).

### <Departure Examination Procedure (1)>

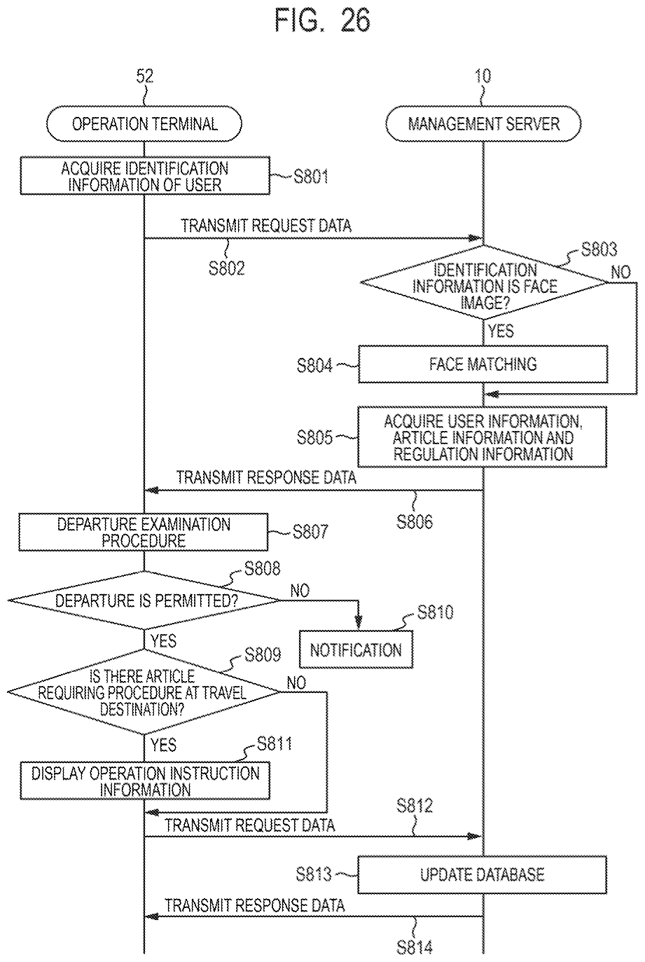

FIG. 26 is a sequence chart illustrating an example of a process performed by the information processing system 2 at the time of departure examination. This process is performed when the user U who has completed the security inspection procedure undergoes the departure procedure in the manned counter in which the staff S exists.

First, the operation terminal 52 acquires identification information of the user U based on an operation of the staff S (step S801). Here, the identification information of the user U is a face image (biometric information) of the user U or a passport number read from a medium such as a passport. The biometric information recorded in the IC card of the passport can also be used as the identification information of the user U.

Next, the operation terminal 52 transmits the request data to the management server 10 (step S802). The request data includes identification information of the user U and a request to transmit the user information and the article information. When a face image (biometric information) is acquired as identification information of the user U, the face image data is included.

When receiving the request data from the operation terminal 52, the management server 10 determines whether or not the identification information of the user U included in the request data is a face image (step S803). Here, when the management server 10 determines that the identification information of the user U is a face image (YES in step S803), the process proceeds to step S804. On the other hand, when the management server 10 determines that the identification information of the user U is the passport number (NO in step S803), the process proceeds to step S805.

In step S804, the management server 10 performs face matching of the user U. That is, the management server 10 performs one-to-N matching between the target face image received from the operation terminal 52 and a plurality of registered face images registered in the user information DB 11.

In step S805, the management server 10 acquires user information, article information, and regulation information. At this time, the management server 10 acquires regulation information from the regulation information DB 14 based on the country code of the travel destination. Next, the management server 10 transmits response data including the user information, the article information, and the regulation information to the operation terminal 52 (step S806).

In step S807, the operation terminal 52 performs a departure examination procedure based on the response data received from the management server 10 and the operation of the staff S. Next, the operation terminal 52 determines whether or not the departure of the user U is permitted (step S808).

Here, when the operation terminal 52 determines that the departure of the user U is permitted (YES in step S808), the process proceeds to step S809. On the other hand, when the operation terminal 52 determines that the departure of the user U is not permitted (NO in step S808), the operation terminal 52 notifies the error information (step S810).

In step S809, based on the article information included in the response data, the operation terminal 52 determines whether or not there is an article requiring another procedure at the travel destination (the second country) in the baggage of the user U. Here, when the operation terminal 52 determines that there is an article requiring another procedure at the travel destination (YES in step S809), the operation instruction information is displayed (step S811), and the process proceeds to step S812.

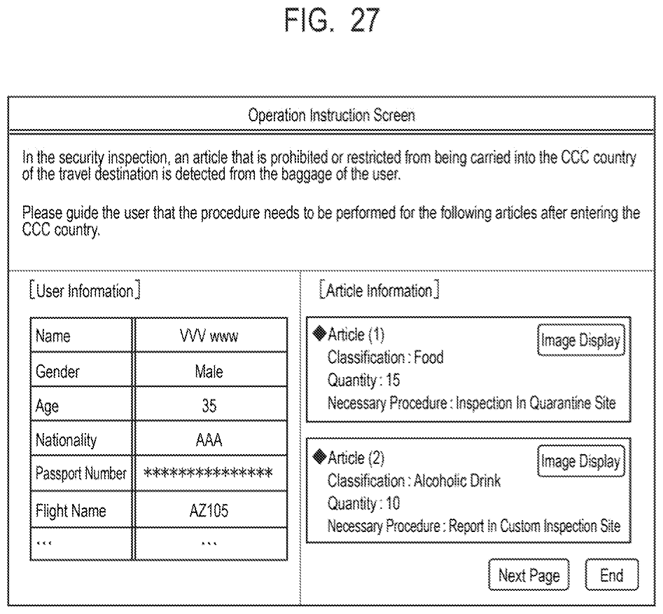

FIG. 27 is a diagram illustrating an example of a screen displayed on the operation terminal 52. Here, the screen includes the following message of an operation instruction for the staff S. “In the security inspection, an article that is prohibited or restricted from being carried into the CCC country of the travel destination is detected from the baggage of the user. Please guide the user that the procedure needs to be performed for the following articles after entering the CCC country.” The screen includes user information of the user U, and article information. The operation instruction screen may further display a face image of the user U or a face image of a passport.

On the other hand, when the operation terminal 52 determines that there is no article requiring another procedure at the travel destination (NO in step S809), the process proceeds to step S812.

In step S812, the operation terminal 52 transmits the request data to the management server 10. The request data includes a user ID, results of departure examination procedures, and a database update request.

Next, when receiving the request data from the operation terminal 52, the management server 10 updates the user information DB 11 (step S813). More specifically, the management server 10 updates the status of the user information DB 11 to “completion of the departure examination procedure” using the user ID as a key.

Then, the management server 10 transmits the response data including the process result to the operation terminal 52 (step S814), and ends the process.

### <Departure Examination Procedure (2)>

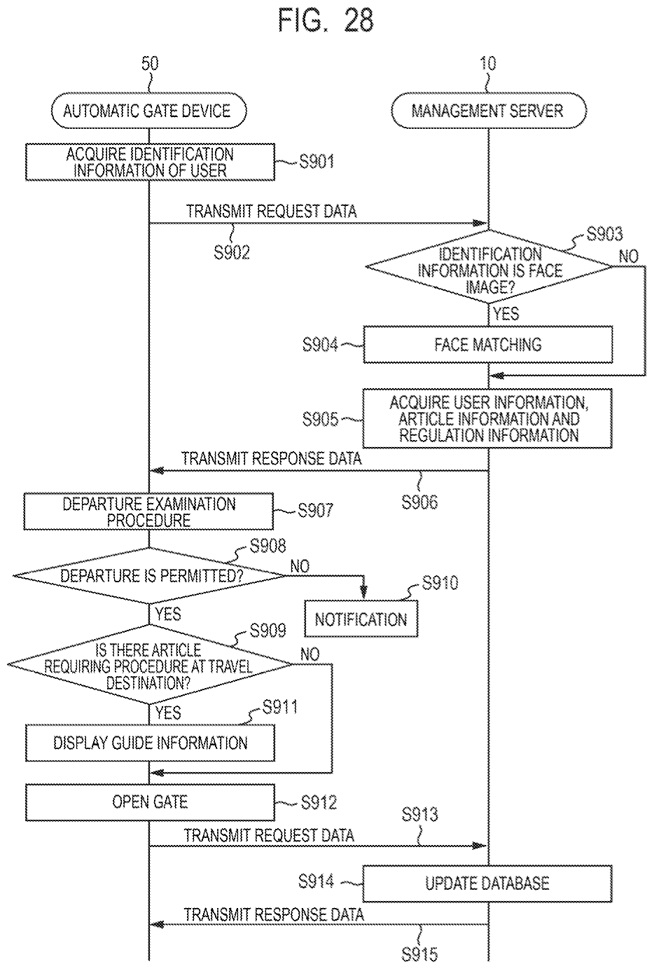

FIG. 28 is a sequence chart illustrating an example of a process performed by the information processing system 2 at the time of departure examination. This process is performed when the user U who has completed the security inspection procedure undergoes the departure examination procedure by the automatic gate device 50.

First, the automatic gate device 50 acquires identification information of the user U (step S901). Here, the identification information of the user U is a face image (biometric information) of the user U or a passport number read from a medium such as a passport. The biometric information recorded in the IC card of the passport can also be used as the identification information of the user U.

Next, the automatic gate device 50 transmits the request data to the management server 10 (step S902). The request data includes identification information of the user U and a request to transmit the user information and the article information. When a face image (biometric information) is acquired as identification information of the user U, the face image data is included.

When receiving the request data from the automatic gate device 50, the management server 10 determines whether or not the identification information of the user U included in the request data is a face image (step S903).

Here, when the management server 10 determines that the identification information of the user U is a face image (YES in step S903), the process proceeds to step S904. On the other hand, when the management server 10 determines that the identification information of the user U is the passport number (NO in step S903), the process proceeds to step S905.

In step S904, the management server 10 performs face matching of the user U. That is, the management server 10 performs one-to-N matching between the target face image received from the automatic gate device 50 and a plurality of registered face images registered in the user information DB 11.

In step S905, the management server 10 acquires user information, article information, and regulation information. At this time, the management server 10 acquires regulation information from the regulation information DB 14 based on the country code of the travel destination. Next, the management server 10 transmits the response data including the user information, the article information, and the regulation information to the automatic gate device 50 (step S906).

In step S907, the automatic gate device 50 automatically performs a departure examination procedure based on the response data received from the management server 10. Next, the automatic gate device 50 determines whether or not the departure of the user U is permitted (step S908).

Here, when the automatic gate device 50 determines that the departure of the user U is permitted (YES in step S908), the process proceeds to step S909. On the other hand, when the automatic gate device 50 determines that the country of the user U is not permitted (NO in step S908), the automatic gate device 50 notifies the error information (step S910).

In step S909, the automatic gate device 50 determines whether or not there is an article requiring another procedure in the baggage of the user based on the article information included in the response data. Here, when the automatic gate device 50 determines that there is an article requiring another procedure at the travel destination (YES in step S909), guide information for the user U is displayed (step S911), and the process proceeds to step S912.

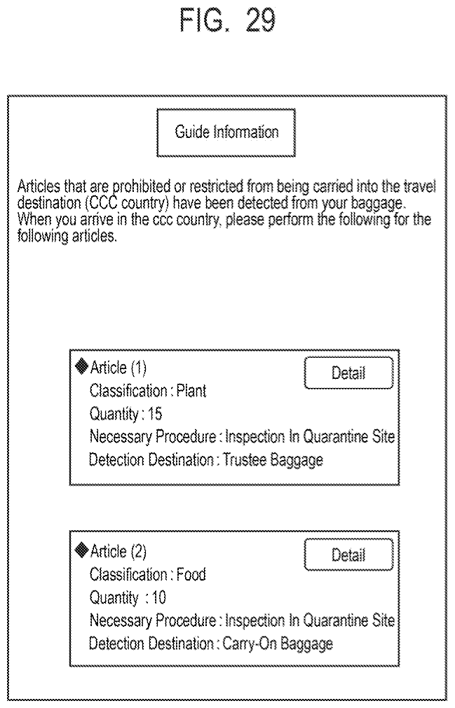

FIG. 29 is a diagram illustrating an example of a screen displayed on the automatic gate device 50. Here, the screen includes the following message to guide a procedure necessary for carrying the article to the user U and the article information. “Articles that are prohibited or restricted from being carried into the travel destination (CCC country) have been detected from your baggage. When you arrive in the CCC country, please perform the following procedure for the following articles.”

On the other hand, when the automatic gate device 50 determines that there are no articles requiring other procedures at the travel destination (NO in step S909), the process proceeds to step S912.

In step S912, the automatic gate device 50 opens the gate. Next, the automatic gate device 50 transmits the request data to the management server 10 (step S913). The request data includes a user ID, results of departure examination procedures, and a database update request.

Next, when receiving the request data from the automatic gate device 50, the management server 10 updates the user information DB 11 (step S914). More specifically, the management server 10 updates the status of the user information DB 11 to “completion of the departure examination procedure” using the user ID as a key.

Then, the management server 10 transmits the response data including the process result to the automatic gate device 50 (step S915), and ends the process.

As described above, the information processing system 2 (management server 10) of the present example embodiment further includes a function of providing information about a target article to the user U before the travel in the examination procedure in the first country. Thereby, the user U can know in advance the procedure performed on the target article in the second country. As a result, the procedure for the entry to the second country can be made more efficient.

### Third Example Embodiment

The information processing system 3 (management server 10) of the present example embodiment is different from the above-described example embodiment in that the information processing system 3 (management server 10) includes a function of notifying a display terminal other than a device used in a procedure for entry or departure whether or not a user U has a target article.

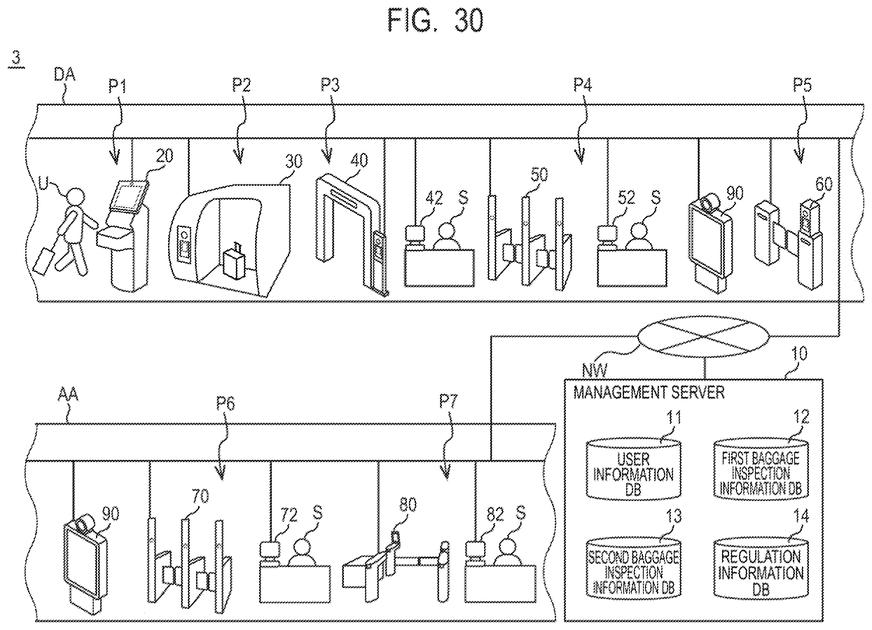

FIG. 30 is a schematic diagram illustrating an example of a general configuration of the information processing system 3 according to the present example embodiment. As illustrated in FIG. 30, a signage terminal 90 is installed in each of the airport DA in the first country and the airport AA in the second country. The plurality of signage terminals 90 are connected to the management server 10 via the network NW.

The signage terminal 90 is a display terminal that acquires article information from the management server 10 based on the identification information acquired from the user U, and displays guide information for guiding the user U with the information of the target article in the second country and the procedure necessary for carrying the target article at the time of entering the second country.

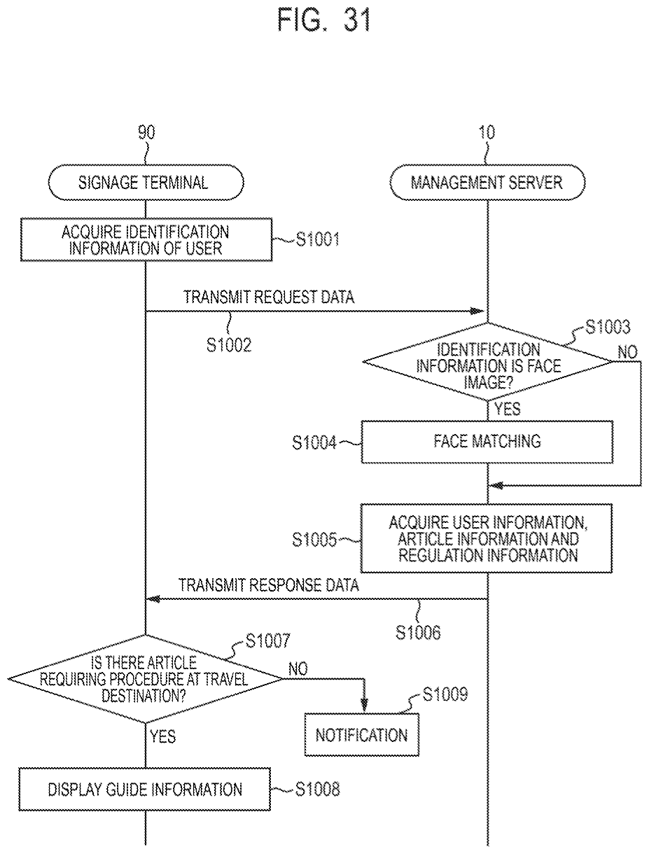

FIG. 31 is a sequence chart illustrating an example of a process in the information processing system 3. This process is automatically performed, for example, when the user U stands in front of the signage terminal 90 or when the user U holds a passport over the signage terminal 90.

First, the signage terminal 90 acquires identification information of the user U (step S1001). Here, the identification information of the user U is a face image (biometric information) of the user U or a passport number read from a medium such as a passport. The biometric information recorded in the IC card of the passport can also be used as the identification information of the user U.

Next, the signage terminal 90 transmits the request data to the management server 10 (step S1002). The request data includes identification information of the user U and a request for transmission of user information, article information, and regulation information. When a face image (biometric information) is acquired as identification information of the user U, the user information includes data of the face image.

When receiving the request data from the signage terminal 90, the management server 10 determines whether or not the identification information of the user U included in the request data is a face image (step S1003). Here, when the management server 10 determines that the identification information of the user U is a face image (YES in step S1003), the process proceeds to step S1004. On the other hand, when the management server 10 determines that the identification information of the user U is the passport number (NO in step S1003), the process proceeds to step S1005.

In step S1004, the management server 10 performs face matching of the user U. That is, the management server 10 performs one-to-N matching between the target face image received from the signage terminal 90 and a plurality of registered face images registered in the user information DB 11.

In step S1005, the management server 10 acquires user information, article information, and regulation information. At this time, the management server 10 acquires regulation information from the regulation information DB 14 based on the country code of the travel destination. Next, the management server 10 transmits the response data including the user information, the article information, and the regulation information to the signage terminal 90 (step S1006).

Next, based on the article information and the regulation information included in the response data, the signage terminal 90 determines whether or not there is an article necessary for another procedure in the second country of the travel destination in the baggage of the user U (step S1007).

Here, when the signage terminal 90 determines that there is an article requiring another procedure at the travel destination (YES in step S1007), the signage terminal 90 displays guide information (step S1008), and the process ends.

On the other hand, when the signage terminal 90 determines that there are no articles requiring other procedures at the travel destination (NO in step S1007) the signage terminal 90 displays a message indicating that there are no articles requiring other procedures (step S1009), and the process ends.

As described above, the information processing system 3 (management server 10) according to the present example embodiment has a function of notifying whether or not the user U has a target article to the display terminal (signage terminal 90) other than the device used in the procedure for the entry or the departure. Thereby, the user U can know in advance the procedure performed on the target article in the second country in various places in the first country and the second country. As a result, the procedure in the second country can be made more efficient.

### Forth Example Embodiment

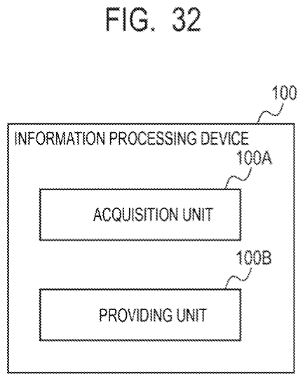

FIG. 32 is a schematic diagram illustrating an example of a general configuration of the information processing device 100 according to the present example embodiment. The information processing device 100 includes an acquisition unit 100A and a providing unit 100B. The acquisition unit 100A acquires the article information indicating the article included in the baggage of the passenger in the security inspection of the first country. The providing unit 100B provides the article information to the device used for the procedure for the entry to the second country of the passenger.

According to the present example embodiment, there is provided the information processing device 100 capable of improving the efficiency of the procedure for the entry of the passenger.

### Fifth Embodiment

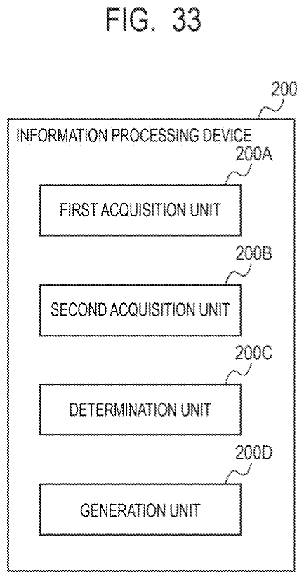

FIG. 33 is a schematic diagram illustrating an example of a general configuration of the information processing device 200 according to the present example embodiment. The information processing device 200 includes a first acquisition unit 200A, a second acquisition unit 200B, a determination unit 200C, and a generation unit 200D. The first acquisition unit 200A acquires the article information indicating the articles included in the baggage of the passenger who travels to the second country in the security inspection of the first country. The second acquisition unit 200B acquires regulations relating to the carrying of articles into the second country. The determination unit 200C performs determination processing for determining whether or not the carrying of the article to the second country is restricted based on the article information and the regulation. Based on the result of the determination processing, the generation unit 200D generates guide information for guiding the procedure imposed on the carrying of the article to the second country to the passenger before the travel.

According to the present example embodiment, there is provided the information processing device 200 capable of improving the efficiency of the procedure relating to the entry of the passenger.

### Modified Embodiments

The present invention is not limited to the example embodiments described above, and can be appropriately modified without departing from the scope of the present invention. For example, an example in which some of the configurations of any of the example embodiments are added to other example embodiments or an example in which some of the configurations of the other example embodiments are substituted is also an example embodiment of the present invention.

In the above-described example embodiment, the case has been described in which the user U enters or departs by airplane. However, the present invention is also applicable to the case where the user U enters or departs from a seaport or a border.

A plurality of servers may have the functions of the management server 10. For example, servers may be provided in the first country and the second country to communicate between the servers. The provision of article information from a server in the first country to a server in the second country may not necessarily be at the time of procedures in the second country. Before the airplane departs from the airport DA of the first country and arrives at the airport AA of the second country, the server of the first country may provide the server of the second country with the article information together with the boarding information.

Further, the article information of the target article detected in the first country can be used in a situation other than the procedure for the entry. For example, the action of the user U in which the target article is detected may be tracked by a camera disposed at each location of the airport, and the captured image may be stored. Thereby, it is possible to monitor whether or not the user U hands over the target article to another person.

In addition, in the case where the prohibited/restricted article is included in the trustee baggage, the current position and area of the user U may be identified based on the passage history of each touch point of the corresponding user U, and the staff S may be notified. The passage history of the touch point is, for example, the execution history of the face authentication process or the execution history of the ticket reading process such as the boarding ticket. Further, when the current position or area of the user U is identified, the user U may be detected using a monitoring camera installed in the vicinity of the user U and a face authentication technology, and the user U may be notified to the staff S located in the vicinity of the user U by including a face photograph.

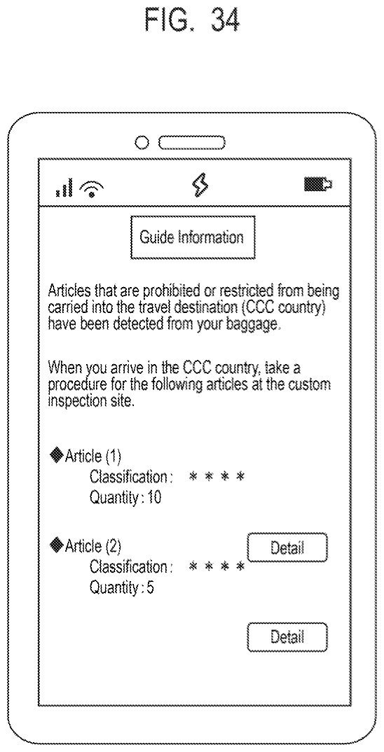

Further, in the above-described example embodiment, the notification destination of the article information is limited to the device disposed in the airport. For example, by associating the contact of the user terminal possessed by the user U with the boarding reservation information of the user U, the user terminal may be notified of the article information. FIG. 34 is a diagram illustrating an example of a screen displayed on a user terminal according to a modified example embodiment. Here, the screen includes the following message to guide a procedure necessary for carrying the article to the user U and the article information. “Articles that are prohibited or restricted from being carried into the travel destination (CCC country) have been detected from your baggage. When you arrive in the CCC country, take a procedure for the following articles at the custom inspection site.”.

The timing of notifying the user terminal of the message as illustrated in FIG. 34 includes, for example, (A) the timing at which the baggage is inspected at the time of the country, (B) the timing of the departure examination, (C) the timing of the entry examination, and (D) the timing of the custom inspection, but the notification timing is not limited thereto. Further, in addition to the messages described above, the user terminal may be notified of information such as the position information of the airplane and the flight information (the takeoff time and the expected arrival time).

Further, in the above-described example embodiment, the case where the article information and the message of the target article are displayed on the screen has been described, but the notification method is not limited to the screen display. For example, the automatic gate device 70 or the like may print out the article information on a predetermined sheet and provide the article information to the user U.

Further, in the above-described example embodiment, the configuration has been described in which the target article is detected from both the first baggage that is carried into the cabin by the traveler boarding on the transportation equipment and the second baggage that the traveler has deposited before boarding, but the configuration may be such that at least one of the first baggage and the second baggage is used as a target to generate the article information.

A processing method in which a program for operating the configuration of the above-described example embodiments is recorded in a storage medium so as to implement the functions of the above-described example embodiments, the program recorded in the storage medium is read as code, and the program is executed in a computer is also included in the scope of each example embodiment. That is, a computer-readable storage medium is also included in the scope of the example embodiments. Further, not only the storage medium in which the above program is recorded, but also the program itself is included in each example embodiment. In addition, one or more components included in the above-described example embodiments may be a circuit such as an application specific integrated circuit (ASIC), a field programmable gate array (FPGA) configured to implement the functions of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each example embodiment is not limited to the case where the processing is executed by the program alone recorded in the storage medium, and a case where the processing is executed by operating on an operating system (OS) in cooperation with the functions of other software and extension board is also included in the scope of each example embodiment.

The service realized by the functions of the above-described example embodiments may be provided to the user in the form of a software as a service (SaaS).

It should be noted that the above-described example embodiments are merely examples of embodying the present invention, and the technical scope of the present invention should not be limitedly interpreted by these. That is, the present invention can be implemented in various forms without departing from the technical idea or the main features thereof.

The whole or part of the example embodiments disclosed above can be described as, but not limited to, the following supplementary notes.

### (Supplementary Note 1)

An information processing device comprising: an acquisition unit that acquires article information indicating an article included in baggage of a passenger in a security inspection of a first country; and

a providing unit that provides the article information to a device used for a procedure for an entry into a second country of the passenger.

### (Supplementary Note 2)

The information processing device according to supplementary note 1, wherein the article information includes information about the article which is permitted to be carried into a transportation equipment used by the passenger for a travel and restricted to be carried into the second country.

### (Supplementary Note 3)

The information processing device according to supplementary note 1 or 2, wherein the article information includes a classification according to regulations applied to the article in the second country.

### (Supplementary Note 4)

The information processing device according to any one of supplementary notes 1 to 3, wherein the article information includes information on a quantity of each of the article.

### (Supplementary Note 5)

The information processing device according to any one of supplementary notes 1 to 4, wherein the procedure includes at least one of a custom procedure, a quarantine procedure, and an entry examination procedure.

### (Supplementary Note 6)

The information processing device according to supplementary note 2, wherein the baggage is at least one of first baggage that is carried into a cabin by the passenger boarding on the transportation equipment and second baggage that the passenger has deposited before boarding.

### (Supplementary Note 7)

The information processing device according to any one of supplementary notes 1 to 6, wherein the providing unit provides the article information to the device operated by a staff in the procedure.

### (Supplementary Note 8)

The information processing device according to any one of supplementary notes 1 to 6, wherein the providing unit provides the article information to the device that automatically performs the procedure.

### (Supplementary Note 9)

The information processing device according to any one of supplementary notes 1 to 8 further comprising a storage unit that store registered biometric information of the passenger in association with the article information.

### (Supplementary Note 10)

The information processing device according to supplementary note 9, wherein the providing unit provides the device with the article information associated with the registered biometric information by performing biometric matching of biometric information of the passenger acquired by the device with the registered biometric information.

### (Supplementary Note 11)

The information processing device according to supplementary note 11, wherein the biometric information and the registered biometric information are face images of the passenger.

### (Supplementary Note 12)

The information processing device according to any one of supplementary notes 1 to 8 further comprising a storage unit that stores identification information of the passenger in association with the article information, wherein the providing unit provides the device with the article information associated with the identification information based on the identification information of the passenger acquired from a medium carried by the passenger in the device.

### (Supplementary Note 13)

The information processing device according any one of supplementary notes 1 to 12, wherein the providing unit provides the article information to the device and a terminal device previously associated with identification information of the passenger.

### (Supplementary Note 14)

An information processing method comprising:

acquiring article information indicating an article included in baggage of a passenger in a security inspection of a first country; and

providing the article information to a device used for a procedure for an entry into a second country of the passenger.

### (Supplementary Note 15)

A storage medium storing a program that causes a computer to perform:

acquiring article information indicating an article included in baggage of a passenger in a security inspection of a first country; and

providing the article information to a device used for a procedure for an entry into a second country of the passenger.

### (Supplementary Note 16)

An information processing device comprising:

a first acquisition unit that acquires, in a security inspection of a first country, article information indicating an article included in baggage of a passenger who travels to a second country;

a second acquisition unit that acquires a regulation relating to carrying the article into the second country;

a determination unit that performs a determination process for determining whether or not carrying the article into the second country is restricted based on the article information and the regulation; and

a generation unit that generates guide information for guiding a procedure imposed on carrying the article into the second country to the passenger based on a result of the determination process.

### (Supplementary Note 17)

An information processing method comprising:

acquiring, in a security inspection of a first country, article information indicating an article included in baggage of a passenger who travels to a second country;

acquiring a regulation relating to carrying the article into the second country;

performing a determination process for determining whether or not carrying the article into the second country is restricted based on the article information and the regulation; and

generating guide information for guiding a procedure imposed on carrying the article into the second country to the passenger based on a result of the determination process.

### (Supplementary Note 18)

A storage medium storing a program that causes a computer to perform:

acquiring, in a security inspection of a first country, article information indicating an article included in baggage of a passenger who travels to a second country;

acquiring a regulation relating to carrying the article into the second country;

performing a determination process for determining whether or not carrying the article into the second country is restricted based on the article information and the regulation; and

generating guide information for guiding a procedure imposed on carrying the article into the second country to the passenger based on a result of the determination process.

### REFERENCE SIGNS LIST

NW network
U, U1 to U11 user
S, S1 to S5 staff
1, 2, 3 information processing system
10 management server
10a link unit
10b baggage inspection unit
10c body inspection unit
10d article information acquiring unit
10e storage unit
10f matching unit
10g article information providing unit
10h determination unit
11 user information DB
12 first baggage inspection information DB
13 second baggage inspection information DB
14 regulation information DB
20 check-in terminal
30 automatic baggage deposition device
40 security inspection device
50, 70 automatic gate device
60 boarding gate device
80 automatic custom gate device
90 signage terminal
402 passage control device
403 baggage conveyance device
404 camera
405 baggage inspection device
406 body inspection device
409 signage terminal
410 deposition box

What is claimed is:

1. An information processing device comprising:
at least one memory storing instructions; and
at least one processor configured to execute the instructions to:
acquire article information indicating an article included in baggage of a passenger in a security inspection of a first country; and
provide the article information to a device used for a procedure for an entry into a second country of the passenger.

2. The information processing device according to claim 1, wherein the article information includes information about the article which is permitted to be carried into a transportation equipment used by the passenger for a travel and restricted to be carried into the second country.

3. The information processing device according to claim 1, wherein the article information includes a classification according to regulations applied to the article in the second country.

4. The information processing device according to claim 1, wherein the article information includes information on a quantity of each of the article.

5. The information processing device according to claim 1, wherein the procedure includes at least one of a custom procedure, a quarantine procedure, and an entry examination procedure.

6. The information processing device according to claim 2, wherein the baggage is at least one of first baggage that is carried into a cabin by the passenger boarding on the transportation equipment and second baggage that the passenger has deposited before boarding.

7. The information processing device according to claim 1, wherein the at least one processor is further configured to execute the instructions to:
provide the article information to the device operated by a staff in the procedure.

8. The information processing device according to claim 1, wherein the at least one processor is further configured to execute the instructions to:
provide the article information to the device that automatically performs the procedure.

9. The information processing device according to claim 1, wherein the at least one processor is further configured to execute the instructions to:
store registered biometric information of the passenger in association with the article information.

10. The information processing device according to claim 9, wherein the at least one processor is further configured to execute the instructions to:
provide the device with the article information associated with the registered biometric information by performing biometric matching of biometric information of the passenger acquired by the device with the registered biometric information.

11. The information processing device according to claim 10, wherein the biometric information and the registered biometric information are face images of the passenger.

12. The information processing device according to claim 1, wherein the at least one processor is further configured to execute the instructions to:
store identification information of the passenger in association with the article information,
provide the device with the article information associated with the identification information based on the identification information of the passenger acquired from a medium carried by the passenger in the device.

13. The information processing device according claim 1, wherein the at least one processor is further configured to execute the instructions to:
provide the article information to the device and a terminal device previously associated with identification information of the passenger.

14. An information processing method comprising:
acquiring article information indicating an article included in baggage of a passenger in a security inspection of a first country; and
providing the article information to a device used for a procedure for an entry into a second country of the passenger.

15. A storage medium storing a program that causes a computer to perform:
acquiring article information indicating an article included in baggage of a passenger in a security inspection of a first country; and
providing the article information to a device used for a procedure for an entry into a second country of the passenger.

16. An information processing device comprising:
at least one memory storing instructions; and
at least one processor configured to execute the instructions to:
acquire, in a security inspection of a first country, article information indicating an article included in baggage of a passenger who travels to a second country;
acquire a regulation relating to carrying the article into the second country;
perform a determination process for determining whether or not carrying the article into the second country is restricted based on the article information and the regulation; and
generate guide information for guiding a procedure imposed on carrying the article into the second country to the passenger based on a result of the determination process.

17. An information processing method comprising:
acquiring, in a security inspection of a first country, article information indicating an article included in baggage of a passenger who travels to a second country;
acquiring a regulation relating to carrying the article into the second country;
performing a determination process for determining whether or not carrying the article into the second country is restricted based on the article information and the regulation; and
generating guide information for guiding a procedure imposed on carrying the article into the second country to the passenger based on a result of the determination process.

18. A non-transitory storage medium storing a program that causes a computer to perform:
acquiring, in a security inspection of a first country, article information indicating an article included in baggage of a passenger who travels to a second country;
acquiring a regulation relating to carrying the article into the second country;
performing a determination process for determining whether or not carrying the article into the second country is restricted based on the article information and the regulation; and
generating guide information for guiding a procedure imposed on carrying the article into the second country to the passenger based on a result of the determination process.
